(19) United States
(12) Patent Application Publication
(10) Pub. No.: US 2026/0287187 A1
(43) Pub. Date: Sep. 24, 2026

(54) HEAT PUMP

(71) Applicant: LG ELECTRONICS INC., Seoul (KR)

(72) Inventors: Kiyoon PARK, Seoul (KR); ILHAN YUN, Seoul (KR); Jonghae LEE, Seoul (KR); Taeho KONG, Seoul (KR); Gwansoo LEE, Seoul (KR); Jungyoon KIM, Seoul (KR); Dongmin SEO, Seoul (KR); Changgeun HAN, Seoul (KR)

(73) Assignee: LG ELECTRONICS INC., Seoul (KR)

(21) Appl. No.: 19/571,139

(22) Filed: Mar. 18, 2026

(30) Foreign Application Priority Data
Mar. 18, 2025 (KR) 10-2025-0034634

(51) Int. Cl. F24F 5/00; F24F 11/30; F24F 140/12; F24F 140/20

(52) U.S. Cl. CPC F24F 5/0003; F24F 11/30; F24F 2140/12; F24F 2140/20

(57) ABSTRACT

A heat pump includes a water inlet pipe assembly including a water inlet pipe, the water inlet pipe assembly being configured to receive water from an outside, the water inlet pipe comprising a plastic material, a pump configured to circulate the water introduced from the water inlet pipe assembly, a heat exchanger configured to exchange heat between the water circulated from the pump and a refrigerant, and a water outlet pipe assembly configured to allow the heat-exchanged water to flow therethrough to the outside.

### CROSS-REFERENCE TO RELATED APPLICATIONS

This application claims priority to Korean Patent Application No. 10-2025-0034634 filed on March 18, 2025, in the Korean Intellectual Property Office, the entire contents of which are hereby expressly incorporated by reference into the present application.

### TECHNICAL FIELD

This disclosure relates to a heat pump.

### BACKGROUND

An air-to-water heat pump (AWHP) absorbs heat from the air and heats or cools water. Unlike conventional air-to-air heat pumps, AWHP transfers heat through water, not through air, so that it is widely used for heating, cooling, and hot water supply. For example, it is used together with the underfloor heating, radiator, or hot water storage system of building.

AWHP is designed to operate efficiently in response to the change of indoor and outdoor temperature, and offers higher energy efficiency than gas boiler, so that it is recognized as an economical and environmentally friendly heating and cooling solution. In particular, it is being actively adopted as a renewable energy system in Europe and various countries due to its ability to reduce carbon emissions.

In an AWHP, a refrigerant circulates through a heat pump cycle, absorbs heat from the air, and transfers it to water. In a condenser of the heat pump cycle, the high-temperature, high-pressure refrigerant emits heat to the water to be condensed, and the water is heated by the refrigerant. The heated water is sent to the heating system or hot water supply system of building.

In an existing AWHP system, most water pipes use a metal pipe such as copper Cu or stainless steel SUS, so that a product design is difficult and the processing and installation processes of a pipe are complicated.

### SUMMARY

The disclosure has been made in view of the above problems, and may provide a heat pump including a water pipe having multiple pipes molded from plastic material.

The disclosure may further provide a heat pump in which a sensor coupling portion for connecting a sensor to a water pipe is formed in the water pipe without welding.

The disclosure may further provide a heat pump having a reduced radius of curvature of a water pipe.

The disclosure may further provide a heat pump capable of efficiently utilizing space within a mechanical compartment.

The disclosure may further provide a heat pump having a water pipe adapted to different specifications by varying the connection of multiple pipes.

The disclosure may further provide a heat pump in which components within a mechanical compartment are arranged for easy installation, repair, and maintenance.

According to an aspect of the present disclosure, there is provided a heat pump including a water inlet pipe in which a plurality of pipes are connected to each other.

The plurality of pipes may be formed of a plastic material. The plurality of pipes may be formed of an engineering plastic material. The plurality of pipes may be formed of polyamide 66 (PA66).

The plurality of pipes may be injection molded. The plurality of pipes may be injection molded with a plastic material. The plurality of pipes may be injection molded with an engineering plastic material.

According to an aspect of the present disclosure, a heat pump includes a water inlet pipe assembly which includes a water inlet pipe, and into which water flows from an external source, a pump connected to the water inlet pipe assembly, a heat exchanger for exchanging heat with water discharged through a water outlet pipe of the pump, and a water outlet pipe assembly through which the heat-exchanged water flows out.

The water inlet pipe may be formed of a plastic material.

The water inlet pipe may extend in a front-rear direction.

The heat pump may further include a heat pump cycle having a refrigerant pipe through which refrigerant flows.

The heat pump may further include a water inlet pipe sensor arranged in the water inlet pipe.

The water inlet pipe may include a sensor coupling portion that protrudes radially outward from the water inlet pipe and communicates with an internal flow path of the water inlet pipe.

The water inlet pipe sensor may be coupled to the sensor coupling portion.

The water inlet pipe sensor may include a first temperature sensor for measuring the water temperature of the water inlet pipe. The sensor coupling portion of the water inlet pipe may include a first temperature sensor coupling portion to which the first temperature sensor is coupled.

The water inlet pipe sensor may include a pressure sensor for measuring the water pressure of the water inlet pipe. The sensor coupling portion of the water inlet pipe may include a pressure sensor coupling portion to which the pressure sensor is coupled.

The water inlet pipe may include a water inlet pipe body that extends in a front-rear direction and forms a flow path therein, and a port coupling portion formed at an inlet end of the water inlet pipe body. The water inlet pipe body and the port coupling portion may be formed as one body.

The heat pump may include an inlet port that is coupled to the port coupling portion and connected to an external water pipe.

The water inlet pipe may further include a mount extending radially between the port coupling portion and the water inlet pipe body. The mount may be formed as one body with the water inlet pipe body.

A support panel that is located in a lateral direction of the heat exchanger and faces rearward may be further included.

The water inlet pipe may penetrate the support panel, and the mount may be coupled to the support panel.

The heat pump may further include a flow meter for measuring the flow rate of water flowing into the water inlet pipe, and the flow meter may include a pipe portion coupled to the water inlet pipe.

The water inlet pipe may further include a pipe coupling portion that is formed as one body with the water inlet pipe and coupled to the pipe portion.

The water outlet pipe assembly may include a water outlet pipe that extends in a front-rear direction and is made of a plastic material.

The heat pump may further include a second temperature sensor that is arranged in the water outlet pipe to measure the water temperature of the water outlet pipe.

The water outlet pipe may include a second temperature sensor coupling portion that protrudes outside the radial direction of the water outlet pipe and communicates with an internal flow path of the water outlet pipe.

The second temperature sensor may be coupled to the second temperature sensor coupling portion.

The water outlet pipe assembly may further include a branch pipe that is connected to a water outlet port through which water is discharged from the heat exchanger and coupled to the water outlet connecting pipe.

The heat pump may include an air vent coupled to the branch pipe.

The water inlet pipe may further include a water inlet pipe body that extends in a front-rear direction and forms a flow path therein.

The water inlet pipe body may be inclined with respect to the front-rear direction such that its radius increases from one end toward the other end.

The water inlet pipe may further include a reinforcing rib protruding radially outward from the water inlet pipe body.

The heat pump may include a refrigerant inlet pipe guiding the refrigerant flowing into the heat exchanger, a refrigerant sensor measuring the state of the refrigerant in the refrigerant inlet pipe, and a refrigerant coupling portion that is welded to the refrigerant inlet pipe and coupled to the refrigerant sensor.

The refrigerant sensor may include a refrigerant temperature sensor measuring the temperature of the refrigerant in the refrigerant inlet pipe, and a refrigerant pressure sensor measuring the pressure of the refrigerant in the refrigerant inlet pipe.

The front end of the water outlet pipe assembly may be arranged rearward of the front end of the water inlet pipe assembly.

The refrigerant sensor may be arranged forward of the water outlet pipe assembly.

The water inlet pipe assembly may include an inlet connecting pipe.

The water inlet connecting pipe may include a first coupling portion connected to the water inlet pipe side and a second coupling portion connected to the water inlet pipe of the pump at the front of the pump.

The first coupling portion and the second coupling portion may face rearward.

The water inlet connecting pipe may be made of a plastic material.

The water inlet connecting pipe may include a first water inlet connecting pipe that has the first coupling portion and is bent laterally, and a second water inlet connecting pipe that is connected to the first water inlet connecting pipe and bent rearward to be connected to the water inlet end of the pump.

According to an aspect of the present disclosure, a heat pump includes a heat pump cycle having a refrigerant pipe through which refrigerant flows, a water inlet pipe assembly into which water flows from an external source, a pump having a water inlet end connected to the water inlet pipe assembly, a water outlet pipe assembly for supplying water to the outside, and a heat exchanger that includes a condenser of the heat pump cycle, exchanges heat of the water discharged through the water outlet end of the pump with the refrigerant flowed in through the refrigerant pipe, and discharges the water toward the water outlet pipe assembly.

The water inlet pipe assembly includes a water inlet pipe extending in a front-rear direction, and a first coupling portion connected to the water inlet pipe side and a second coupling portion connected to the water inlet end of the pump at the front of the pump. The first coupling portion and the second coupling portion may include a water inlet connecting pipe facing rearward. The water inlet connecting pipe may be injection-molded from a plastic material.

The water inlet connecting pipe may include a first water inlet connecting pipe that has the first coupling portion and is bent laterally, and a second water inlet connecting pipe that is connected to the first water inlet connecting pipe and bent rearward to be connected to the water inlet end of the pump.

The direction in which the inlet of the first water inlet connecting pipe faces and the direction in which the outlet of the second water inlet connecting pipe faces may be parallel to each other.

The water inlet pipe assembly may include a flow meter arranged between the water inlet pipe and the water inlet connecting pipe.

The water inlet pipe may be arranged on the lateral side of the heat exchanger.

The pump may be arranged in front of the heat exchanger.

The width of the pump in the left-right direction may be greater than the width of the heat exchanger in the left-right direction.

The water inlet pipe may be arranged vertically below the pump when viewed from the front.

The water inlet pipe may extend in a front-rear direction from one side in a lateral direction of the heat exchanger.

The heat exchanger may include a water inlet port connected to the pump, and a second refrigerant port connected to a refrigerant discharge pipe through which refrigerant is discharged from the heat exchanger.

The water inlet port and the second refrigerant port may face forward. The water inlet port may be arranged on the water inlet pipe side. The second refrigerant port may be arranged on the opposite side of the water inlet pipe.

The above-mentioned water outlet pipe assembly may include a water outlet pipe that is connected to a water outlet port for supplying water to the outside, and extends forward from the water outlet port, and a water outlet connecting pipe that is coupled to the water outlet pipe and bent toward the heat exchanger side to be connected to the heat exchanger.

The water outlet connecting pipe may be injection-molded from a plastic material.

The water outlet connecting pipe may include a first water outlet connecting pipe that is coupled to the water outlet pipe and bent laterally, and a second water outlet connecting pipe that is coupled to the first water outlet connecting pipe and bent rearward toward the heat exchanger.

The water outlet pipe assembly may further include a branch pipe that is connected to the water outlet port through which water is discharged from the heat exchanger and coupled to the water outlet connecting pipe.

The heat pump may include an air vent coupled to the branch pipe.

The heat exchanger may include a water outlet port connected to the water outlet pipe assembly side, and a first refrigerant port connected to a refrigerant inlet pipe that guides refrigerant toward the heat exchanger.

The water outlet port of the heat exchanger may be arranged on the water outlet pipe side. The first refrigerant port may be arranged on the opposite side of the water outlet pipe.

According to an aspect of the present disclosure, the water outlet pipe assembly may include a water outlet pipe that is connected to a discharge port for supplying water to the outside, and extends forward from the discharge port, an extension pipe that is coupled to the water outlet pipe and extends forward, and a water outlet connecting pipe that is coupled to the extension pipe, and bent toward the heat exchanger side to be connected to the heat exchanger.

The water outlet connecting pipe may be injection-molded from a plastic material.

The water inlet connecting pipe may include a first water inlet connecting pipe that has the first coupling portion and is connected to the water inlet pipe side and bent laterally, and a second water inlet connecting pipe that is coupled to the first water inlet connecting pipe and bent rearward to be connected to the water inlet end of the pump.

The water outlet connecting pipe may include a first water outlet connecting pipe that is coupled to the extension pipe and bent laterally, and a second water outlet connecting pipe that is coupled to the first water outlet connecting pipe and bent rearward toward the heat exchanger.

The difference between the length of the combination of the extension pipe and the first water outlet connecting pipe in the front-rear direction and the length of the first water inlet connecting pipe in the front-rear direction may be equal to the difference between the length of the first water inlet connecting pipe in the front-rear direction and the length of the first water outlet connecting pipe in the front-rear direction.

The extension pipe may include a third coupling portion coupled to the water outlet pipe.

The first coupling portion of the first water inlet connecting pipe and the third coupling portion of the extension pipe may have the same shape.

The first water outlet connecting pipe includes a fourth coupling portion coupled to the extension pipe, and the fourth coupling portion of the first water outlet connecting pipe, the first coupling portion of the first water inlet connecting pipe, and the third coupling portion of the extension pipe may have the same shape.

The water inlet pipe assembly includes a first water inlet part that includes the water inlet pipe and extends forward from a lateral side of the heat exchanger, a second water inlet part laterally bent from the first water inlet part, and a third water inlet part that is bent rearward from the second water inlet part, is parallel to the first water inlet part, and is connected to the pump.

The second water inlet part may be arranged at an angle with respect to the horizontal.

The second water inlet part may be arranged vertically with respect to the first and third water inlet parts.

The first, second, and third water inlet parts may be arranged on a single plane.

The water outlet pipe assembly may include a first water outlet part that includes the water outlet pipe and extends forward from a lateral side of the heat exchanger, a second water outlet part that is bent laterally from the first water outlet part, and a third water outlet part that is bent rearward from the second water outlet part, is parallel to the first water outlet part, and is connected to the heat exchanger.

The first and third water inlet parts and the first and third water outlet parts may be arranged parallel to each other.

The pump may be arranged forward of the heat exchanger.

The pump may include a heat dissipation unit facing forward. The first and third water inlet parts may be arranged rearward of the heat dissipation unit.

The second water inlet part may overlap with the heat dissipation unit laterally.

The water outlet pipe assembly may be arranged above the pump.

The second water outlet part may be arranged rearward of the second water inlet part.

The heat pump may further include a sensor coupling portion welded to a refrigerant pipe that guides refrigerant flowing into the heat exchanger, and a refrigerant sensor coupled to the sensor coupling portion.

The refrigerant sensor may be arranged forward of the second water outlet part.

The heat pump may further include an expansion tank connected to the pump.

The expansion tank may have a shape in which a vertical height and a front-rear width are greater than a lateral thickness. The first water inlet part and the first water outlet part may be arranged laterally between the expansion tank and the heat exchanger.

According to an aspect of the present disclosure, a heat pump includes a heat pump cycle having a refrigerant pipe through which refrigerant flows, a water inlet pipe assembly into which water flows from the outside, a pump having a water inlet end connected to the water inlet pipe assembly, a water outlet pipe assembly for supplying water to the outside, and a heat exchanger that is composed of a condenser of the heat pump cycle, exchanges heat of the water discharged through the water outlet end of the pump with the refrigerant flowed through the refrigerant pipe, and discharges the water toward the water outlet pipe assembly. The water inlet pipe assembly includes a plurality of pipes that are injection-molded from a plastic material and coupled to each other.

According to an aspect of the present disclosure, a heat pump includes a heat pump cycle having a refrigerant pipe through which refrigerant flows, a water inlet pipe assembly into which water flows from the outside, a pump having a water inlet end connected to the water inlet pipe assembly, a water outlet pipe assembly for supplying water to the outside, and a heat exchanger that is composed of a condenser of the heat pump cycle, exchanges heat of the water discharged through the water outlet end of the pump with the refrigerant flowed through the refrigerant pipe, and discharges the water toward the water outlet pipe assembly.

The water inlet pipe assembly includes a first water inlet part through which water flows in from the outside, and which extends forward from a lateral side of the heat exchanger; a second water inlet part that is laterally bent from the first water inlet part; and a third water inlet part that is bent rearward from the second water inlet part and is parallel to the first water inlet part, and is connected to the pump.

Specific details of other embodiments are included in the detailed description and drawings.

### BRIEF DESCRIPTION OF THE DRAWINGS

The above and other objects, features and advantages of the present invention will be more apparent from the following detailed description in conjunction with the accompanying drawings, in which:

FIG. 1 is a schematic diagram illustrating a flow of refrigerant and water in a heat pump according to an embodiment of the present disclosure;

FIG. 2 is a perspective view of a heat pump according to an embodiment of the present disclosure;

FIG. 3 is a side view of the heat pump illustrated in FIG. 2 with a side panel removed;

FIG. 4 is a rear perspective view illustrating a water pipe module of a heat pump and a refrigerant pipe connected thereto according to an embodiment of the present disclosure;

FIG. 5 is a front view of the heat pump illustrated in FIG. 4;

FIGS. 6 to 12 are perspective views and cross-sectional views of injection molded pipes forming a water inlet pipe assembly and an outlet pipe assembly illustrated in FIG. 5, FIG. 6 illustrates a water inlet pipe, FIG. 7 illustrates an outlet pipe, FIG. 8 illustrates a first connecting pipe, FIG. 9 illustrates a second connecting pipe, FIG. 10 illustrates a third connecting pipe, FIG. 11 illustrates a branch pipe, and FIG. 12 illustrates an extension pipe;

FIG. 13 is a perspective view of a water pipe module of a heat pump according to a first embodiment of the present disclosure, with an expansion tank removed;

FIG. 14 is a side view of the heat pump illustrated in FIG. 13; and

FIG. 15 is a perspective view of a water pipe module of a heat pump according to a second embodiment of the present disclosure, with an expansion tank removed.

### DETAILED DESCRIPTION

Description will now be given in detail according to embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

A singular representation may include a plural representation.

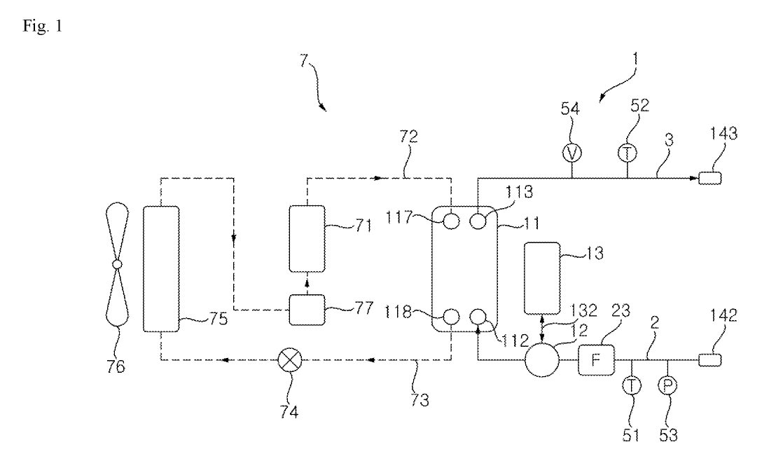

Referring to FIG. 1, a heat pump may include a water pipe module through which a first heat medium flows. The heat pump may include a heat pump cycle 7 through which a second heat medium circulates. The heat pump may include a first heat exchanger 11 in which the first heat medium and the second heat medium exchange heat.

For example, the first heat medium may be in a liquid state in the water pipe module. The first heat medium may be water.

For example, the second heat medium may be a refrigerant. For example, the second heat medium may be R-410a or R-134a. Alternatively, the second heat medium may be a refrigerant with a lower global warming potential (GWP) than R-410a or R-134a. For example, the second heat medium may be a low-GWP refrigerant, such as R-32, R-290, or R-744.

Hereinafter, a case where the first heat medium is water and the second heat medium is refrigerant is illustrated as an example.

The first heat exchanger 11 may be considered as a component of the water pipe module 1 in that water from the water pipe module 1 flows in and is heated. Alternatively, it may be considered as a component of the heat pump cycle 7 in that it serves as a condenser of the heat pump cycle 7 in which high-temperature, high-pressure refrigerant flows in and is condensed. Hereinafter, for convenience of explanation, it is illustrated as a component of the water pipe module 1.

The heat pump cycle 7 includes a compressor 71. The compressor compresses a low-pressure gaseous refrigerant into a high-pressure gaseous refrigerant. The refrigerant is compressed and its temperature increases.

The refrigerant discharged from the compressor 71 flows into the condenser. Here, the condenser refers to the first heat exchanger 11. The refrigerant flowing into the first heat exchanger 11 emits heat and is condensed. The emitted heat may be transferred to water in the first heat exchanger 11.

The condensed refrigerant passes through an expansion valve 74 while lowering its pressure and temperature. The expanded refrigerant flows into the evaporator 75. The evaporator 75 is also referred to as a second heat exchanger. The refrigerant flowing into the evaporator 75 absorbs heat from the air and evaporates.

The heat pump includes a fan 76. The fan 76 circulates air around the second heat exchanger 75, thereby improving the heat exchange performance between the refrigerant and the air.

The refrigerant discharged from the evaporator 75 flows into the compressor 71. Before flowing into the compressor 71, the refrigerant may pass through a gas-liquid separator 77, so that only a gaseous refrigerant can flow into the compressor 71.

The first heat exchanger 11 may include a first refrigerant port 117. The first refrigerant port 117 may be a port through which refrigerant flows into the first heat exchanger 11. Refrigerant discharged from the compressor 71 may flow into the first heat exchanger 117 through the first refrigerant port 117.

A refrigerant inflow pipe 72 may be connected to the first refrigerant port 117. The refrigerant inflow pipe 72 may be connected to the compressor 71.

The first heat exchanger 11 may include a second refrigerant port 118. The second refrigerant port 118 may be a port through which refrigerant from the first heat exchanger 11 is discharged. The refrigerant from the first heat exchanger 11 may be discharged toward the expansion valve 74 through the second refrigerant port.

A refrigerant discharge pipe 73 may be connected to the second refrigerant port 118. The refrigerant discharge pipe 73 may be connected to the expansion valve 71.

The first heat exchanger 11 may include a water inlet port 112. Water may flow into the first heat exchanger 11 through the water inlet port 112.

Water flowing into the first heat exchanger 11 through the water inlet port 112 may be heated through heat exchange with the refrigerant. The refrigerant and the water are not mixed with each other inside the first heat exchanger 11 and transfer heat.

The first heat exchanger 11 may include a water outlet port 113. Water heated inside the first heat exchanger 11 may be discharged through the water outlet port 113.

Inside the first heat exchanger 11, a refrigerant flow path is formed between the first refrigerant port 117 and the second refrigerant port 118, and a water flow path is formed between the water inlet port 112 and the water outlet port 113. Heat transfer may occur between the refrigerant flow path and the water flow path.

For example, the first heat exchanger 11 may be a plate-type heat exchanger. Alternatively, the first heat exchanger 11 may be a tube-type heat exchanger. In the embodiment of the present disclosure, a plate-type heat exchanger is used.

The water pipe module 1 may include a water inlet pipe assembly 2. The water inlet pipe assembly 2 may guide water flowing into the water pipe module 1 to the first heat exchanger 11. The water inlet pipe assembly 2 may be connected to the water inlet port 112.

The water pipe module 1 may include a water outlet pipe assembly 3. The water outlet pipe assembly 3 may guide water discharged from the first heat exchanger 11 to the outside. The water outlet pipe assembly 2 may be connected to the water outlet port 113.

Hereinafter, the term "heat exchanger", regardless of whether it is "first" or "second," may refer to the first heat exchanger 11.

The water pipe module 1 may include a pump 12. The pump 12 may be connected to the water inlet pipe assembly 2.

The pump 12 may be connected to the heat exchanger 11. The pump 12 may be connected to the water inlet port 112 of the heat exchanger 11.

The water inlet pipe assembly 2 may be connected to the heat exchanger 11 through the pump 12. Alternatively, the pump 12 may be considered as a component of the water inlet pipe assembly 2.

The water pipe module 1 may include an expansion tank 13. The expansion tank 13 may control changes in volume according to changes in water temperature.

The expansion tank 13 may be connected to the pump 12. A connecting hose 132 may connect the pump 12 and the expansion tank 13.

The water pipe module 1 may include a pressure sensor 53. The pressure sensor 53 may measure the pressure of water flowing into the water pipe module 1 from the outside.

The pressure sensor 53 may be provided in the water inlet pipe assembly 2. The pressure sensor 53 may measure the pressure of the water inlet pipe assembly 2. The pressure sensor 53 may measure the pressure of the water inlet pipe assembly 2 on the upstream side of the pump 12.

The water pipe module 1 may include a first temperature sensor 51. The first temperature sensor 51 may measure the temperature of water flowing into the water pipe module 1 from the outside.

The first temperature sensor 51 may be provided in the water inlet pipe assembly 2. The first temperature sensor 51 may measure the water temperature of the water inlet pipe assembly 2. The first temperature sensor 51 may measure the water temperature of the water inlet pipe assembly 2 on the upstream side of the pump 12.

The water pipe module 1 may include a flow meter 23. The flow meter 23 may measure the amount of water flowing into the water pipe module 1.

The flow meter 23 may be provided in the water inlet pipe assembly 2. The flow meter 23 may measure the amount of water flowing through the water inlet pipe assembly 2. The flow meter 23 may be a component of the water inlet pipe assembly 2.

The water pipe module 1 may include a second temperature sensor 52. The second temperature sensor 52 may measure the temperature of water heated in the water pipe module 1. The second temperature sensor 52 may measure the temperature of the water that is heated in the water pipe module 1 and to be supplied to the outside.

The second temperature sensor 52 may be provided in the water outlet pipe assembly 3. The second temperature sensor 52 may measure the water temperature of the water outlet pipe assembly 3.

The water pipe module 1 may include an air vent 54. The air vent 54 removes the air existing inside the water pipe module 1. The air vent 54 may be provided in the water outlet pipe assembly 3.

The heat pump may include a discharge port 143. Water heated in the water pipe module 1 may be supplied to the outside through the discharge port 143.

The heat pump may include an inlet port 142. Water may flow into the water pipe module 1 from the outside through the inlet port 142.

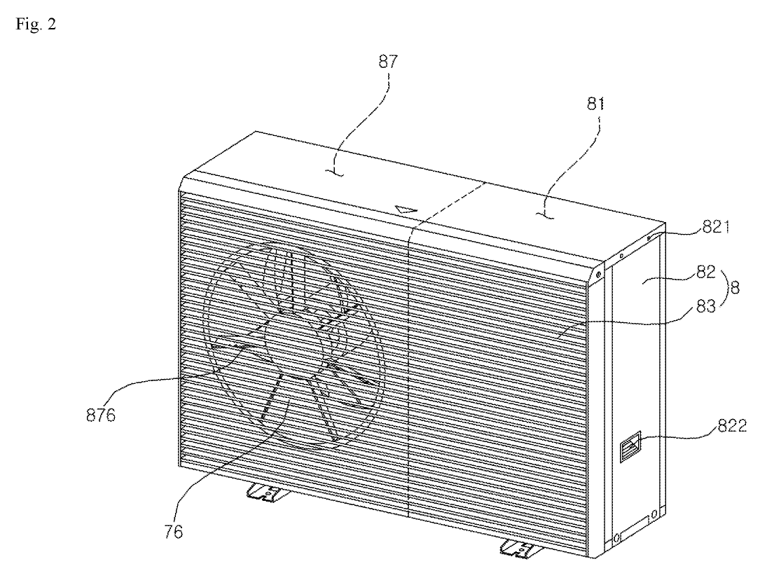

Referring to FIG. 2, the heat pump may include a casing 8. The casing 8 may form the outer shape of the heat pump. A space may be formed inside the casing 8.

The space inside the casing 8 may include a machine compartment 81 and a heat exchange compartment 87. The machine compartment 81 and the heat exchange compartment 87 may be partitioned.

The water pipe module 1 may be arranged in the machine compartment 81. The compressor 71 may be arranged in the machine compartment 81. The water pipe module 1 and the compressor 71 may be arranged in a partitioned space within the machine compartment 81.

The second heat exchanger 75 (see FIG. 1) and the fan 76 may be arranged in the heat exchange compartment 87.

The casing 8 may include a front panel 83. The front panel 83 may be provided with a discharge port 876 on the side of the heat exchange compartment 87. The front panel 83 may cover the front of the machine compartment 81.

The casing 8 may include a side panel 82. The side panel 82 may be arranged on the side of the machine compartment 81.

The side panel 82 may be connected to the casing 8 through a fastening member 821. The fastening member 821 may penetrate the side panel 82 and be screw-connected to the casing 8. The fastening member 821 may be detached using simple tools, etc., and the side panel 82 may be detached from the casing 8. The side panel 82 may include a handle 822.

The side surface of the heat exchange compartment 87 is not closed by a panel, but is open to allow air to pass through, and a filter may cover the open portion.

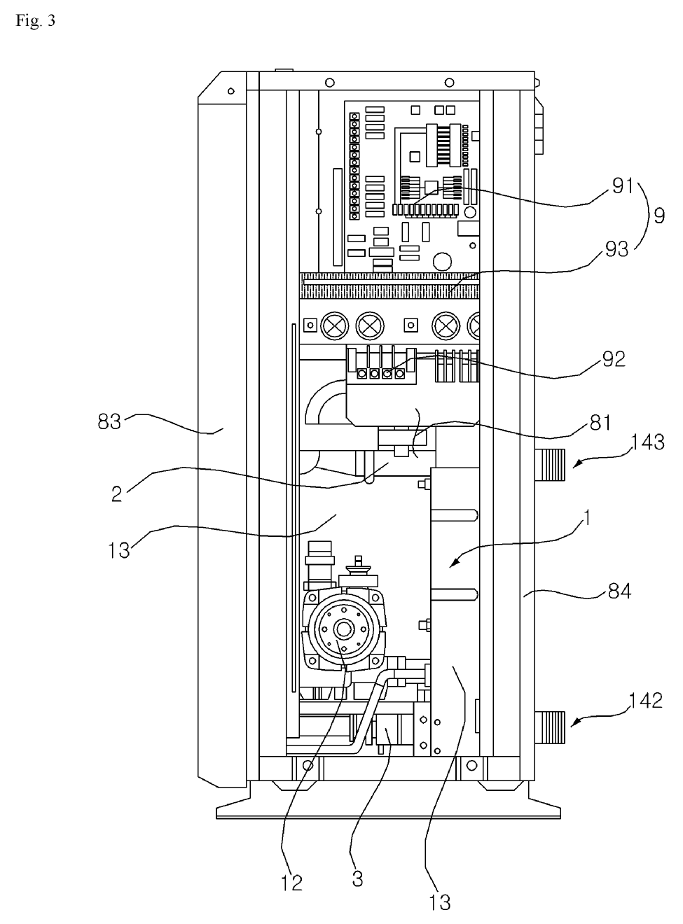

Referring to FIG. 3, the side panel 82 may be detached from the casing 8. When the side panel 82 is detached, a portion of the machine compartment 81 may be exposed to the outside.

An electrical unit 9 may be arranged in the machine compartment 81.

The electrical unit 9 may include a first controller 91. The first controller 91 may receive information/signals from the water pipe module 1 and control the water pipe module 1. For example, the first controller 91 may receive detection values from the first and second temperature sensors 51 and 52, a pressure sensor 53, and the flow meter 23. The first controller 91 may determine the water temperature of the water inlet pipe assembly, the water temperature of the water outlet pipe assembly, the pressure of the water inlet pipe assembly, and the flow rate of the water inlet pipe assembly. The first controller 91 may control the pump 12 and the expansion tank 13.

The electrical unit 9 may include a second controller 92. The second controller 92 may control the heat pump cycle 7. For example, the second controller 92 may control the compressor 71 and the fan 76.

The electrical unit 9 may include a connector 93. External wires may be connected to the connector 93.

The first controller 91 may be connected to the connector 93. Components related to the control of the water pipe module 91 may be connected to the connector 93. The first and second temperature sensors 51, 52, the pressure sensor 53, and the flow meter 23 may be connected to the connector 93. The pump 12 and the expansion tank 13 may be connected to the connector 93.

The second controller 92 may be connected to the connector 93. Components related to the control of the heat pump cycle 7 may be connected to the connector 93. For example, the compressor 71 and the fan 76 may be connected to the connector 93.

Connection to the connector 93 may mean electrical/signal connection.

The side panel 82 may be detachable from the casing 8. The electrical unit 9 may be installed to face the side panel 82. When the side panel 82 is detached, the electrical unit 9 may be exposed to the outside.

Therefore, when installing the heat pump at a location of use, wires may be connected with only the side panel 82 detached. Furthermore, the electrical unit 9 may be repaired and/or maintained by detaching the side panel 82.

The casing 8 may include a rear panel 84. The rear panel 84 may be arranged at the rear of the machine compartment 81. The rear panel 84 may cover the rear of the machine compartment 81.

The discharge port 143 and the inlet port 142 may protrude to the rear of the rear panel 84, i.e., outside the casing 8.

The rear of the heat exchange compartment 87 may not be closed by a panel, but be open to allow air to pass through, and a filter may cover the open portion.

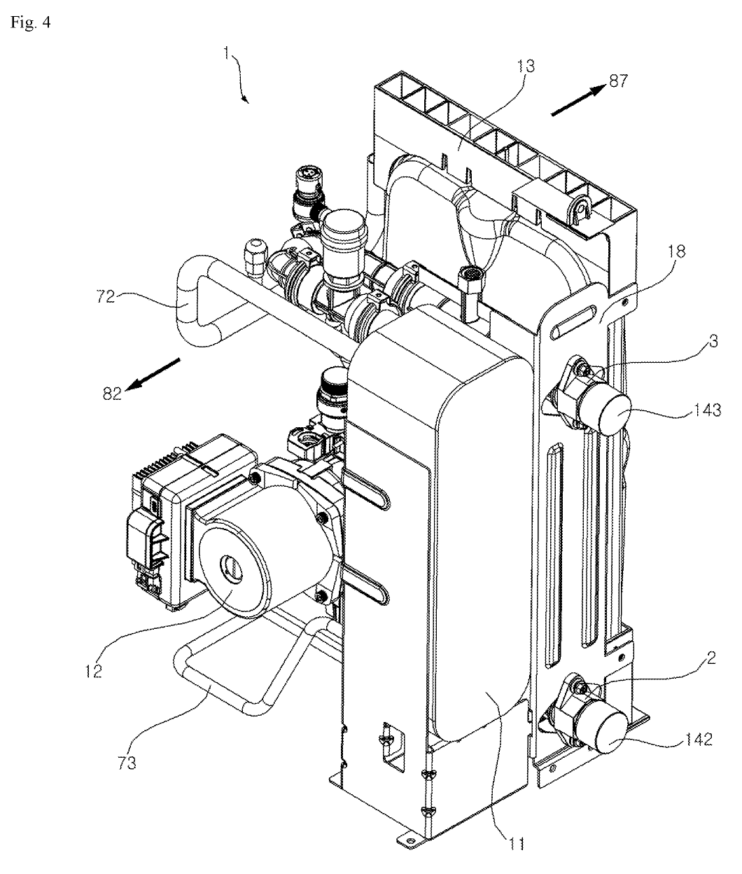

Referring to FIGS. 3 and 4, the expansion tank 13 may be arranged adjacent to the heat exchange compartment 87 side within the machine compartment 81. The water inlet pipe assembly 2, the water outlet pipe assembly 3, the pump 12, and the heat exchanger 11 may be arranged between the expansion tank 13 and the side panel 82.

The heat exchanger 1 may be arranged at the rear within the machine compartment 81. The pump 12 may be arranged at a front of the heat exchanger 11.

The water inlet pipe assembly 2 may be arranged between the expansion tank 13 and the heat exchanger 11. The water outlet pipe assembly 3 may be arranged between the expansion tank 13 and the heat exchanger 11.

The water inlet pipe assembly 2 and the water outlet pipe assembly 3 may extend forward between the expansion tank 13 and the heat exchanger 11, and may be bent toward the heat exchanger 11 from the front end to be connected to the pump 12 or the heat exchanger 11.

A support panel 18 may be arranged laterally between the heat exchanger 11 and the expansion tank 13. The support panel 18 may extend vertically. The support panel 18 may be arranged to face rearward.

The water inlet pipe assembly 2 may penetrate the support panel 18. The water inlet pipe assembly 2 may be coupled to and supported by the support panel 18.

The water outlet pipe assembly 3 may penetrate the support panel 18. The water outlet pipe assembly 3 may be coupled to and supported by the support panel 18.

The expansion tank 13 may be coupled to and supported by the support panel 18.

When the side panel 82 is detached, the water pipe module 1 may be exposed to the outside. When the side panel 82 is detached, the expansion tank 13, the water inlet pipe assembly 2, the water outlet pipe assembly 3, the pump 12, and the heat exchanger 11 may be exposed to the outside.

Accordingly, the side panel 82 may be detached to repair and/or maintain the water pipe assembly 1.

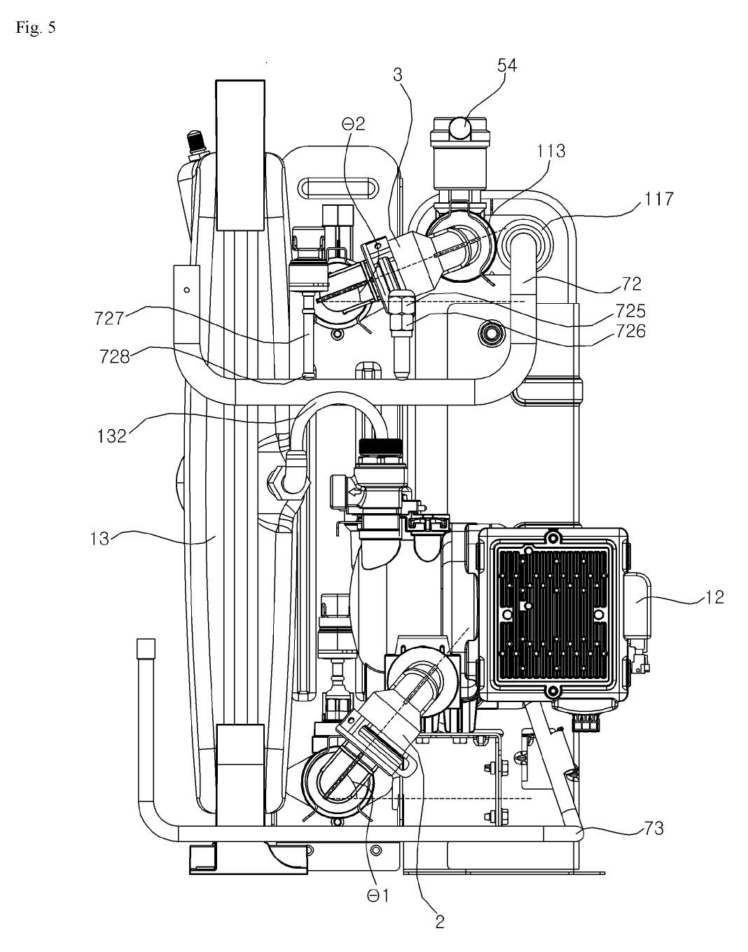

Referring to FIG. 5, the water outlet pipe assembly 3 may be arranged in a relatively upper side, and the water inlet assembly 2 may be arranged in a relatively lower side.

The pump 12 may be arranged at the front of the lower portion of the heat exchanger 11.

The water inlet port 112 may be arranged in a lower portion of the heat exchanger 11. The water inlet port 112 may be arranged at the rear of the pump 12.

The water inlet assembly 2 may be connected to the inlet of the pump 12.

The water inlet assembly 2 may be arranged at an angle with respect to a horizontal.

For example, one side of the water inlet assembly 2 may be laterally spaced away from an inlet of the pump 12 and arranged below the pump.

The other side of the water inlet pipe assembly 2 may be connected to the inlet of the pump 12.

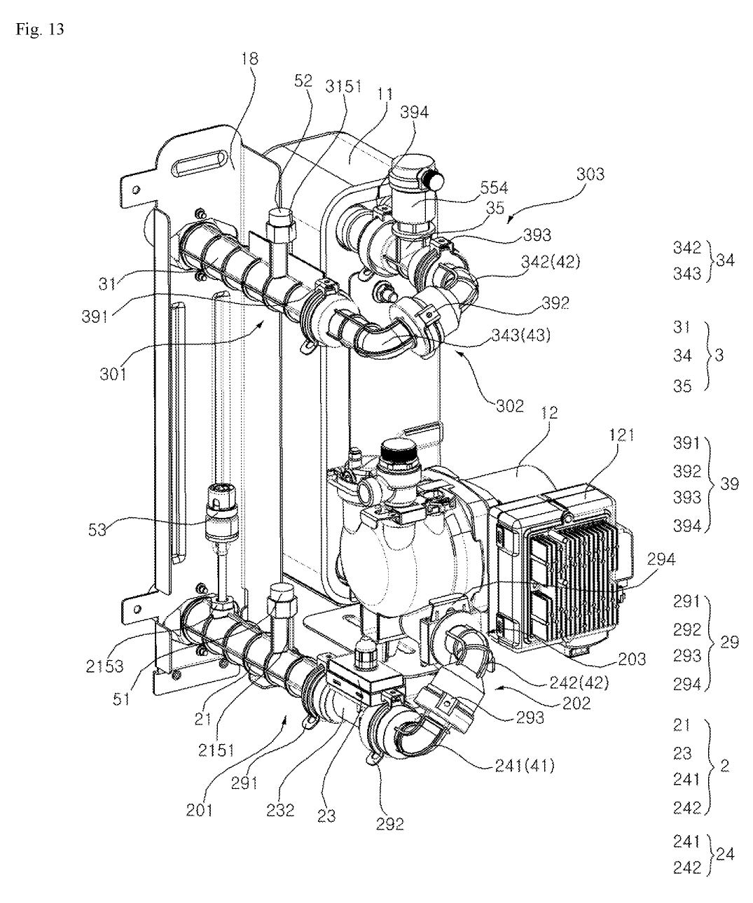

For example, a water inlet connecting pipe 241, 242 described below may be arranged at an angle with respect to a horizontal (see FIG. 13).

The water inlet connecting pipe 241, 242 may be arranged at an angle such that a first water inlet connecting pipe 241, connected to a water inlet pipe 21 side, is arranged at the lower side, and a second water inlet connecting pipe 242, connected to the pump 12, is arranged at the upper side.

For example, a second water inlet part 202 described below may be arranged at an angle with respect to a horizontal (see FIG. 13). The second water inlet part 202 may be arranged at an angle such that one end of the second water inlet part 202, connected to the first water inlet part 201, is arranged at the lower side, and the other end of the second water inlet part 202, connected to the third inlet part 203, is arranged at the upper side.

The water inlet pipe assembly 2 may extend forward from the lower side of the pump 12 and may be bent upward to be connected to the inlet of the pump 12. The water inlet pipe assembly 2 may extend forward from the lower side of the pump 12 and may be bent upward at an angle with respect to a vertical to be connected to the inlet of the pump 12.

The outlet of the pump 12 may be connected to the water inlet port 112. The outlet of the pump 12 may be arranged in a straight line with the water inlet port 112.

The inlet and outlet of the pump 12 may not be arranged in a straight line. For example, when viewed from the front as shown in FIG. 5, the outlet of the pump 12 may be arranged in the same line as the water inlet port of the heat exchanger 11, and the inlet of the pump 12 may be laterally spaced from the water inlet port 112 of the heat exchanger 11.

The angle θ1 at which the water inlet connecting pipe 241, 242 of the water inlet pipe assembly 2 is inclined with respect to a horizontal may be greater than the angle θ2 at which the water outlet connecting pipe 343, 342 of the water outlet pipe assembly 3 is inclined with respect to a horizontal.

The second refrigerant port 118 may be arranged at the lower portion of the heat exchanger 11. The second refrigerant port 118 may be arranged at the rear of the pump 12. The refrigerant discharge pipe 73 may extend forward from the heat exchanger 11. The refrigerant discharge pipe 73 may extend forward but may be bent downward so that it extends forward from the lower side of the pump 12. The refrigerant discharge pipe 73 may extend forward and then toward the heat exchange compartment 87.

The water outlet port 113 and the first refrigerant port 117 may be arranged at the upper portion of the heat exchanger 11.

The water outlet pipe assembly 3 may be connected to the water outlet port 113, and the refrigerant inflow pipe 72 may be connected to the first refrigerant port 117.

The water outlet pipe assembly 3 may be arranged at an angle with respect to a horizontal. For example, one side of the water inlet pipe assembly 3 may be laterally spaced from the water outlet port 113 of the heat exchanger 11 and arranged at the lower side of the water outlet port 3. The other side of the water outlet pipe assembly 3 may be connected to the water outlet port 113.

For example, the water outlet connecting pipe 342, 343 described below may be arranged at an angle with respect to a horizontal (see FIG. 13).

The water outlet connecting pipe 342, 343 may be arranged at an angle such that a first water outlet connecting pipe 343, connected to a water outlet pipe 31 side, is arranged at the lower side, and a second water outlet connecting pipe 342, connected to the heat exchanger 12, is arranged at the upper side.

For example, a second water outlet part 302 described below may be arranged at an angle with respect to a horizontal (see FIG. 13). A third water outlet part 302 may be arranged at an angle such that one end of the second water outlet part 302 connected to the first water outlet part 301 is arranged at the lower side, and the other end of the second water outlet part 302 connected to the third water outlet part 303 is arranged at the upper side.

The air vent 54 may be provided in the water outlet pipe assembly 3 at a position adjacent to the heat exchanger 11. The air vent 54 may be arranged between the other side of the water outlet pipe assembly 3 and the water outlet port 113. The air vent 54 may be arranged between the second water outlet connecting pipe 342 and the water outlet port 113. The air vent 54 may be arranged in the third water outlet part 303. That is, the air vent 54 is arranged on the upper portion of the water outlet pipe assembly 3, so that when air exists in an internal flow path of the water outlet pipe assembly 3, the air may be easily discharged. The water outlet pipe assembly 3 and the refrigerant inflow pipe 72 may be arranged on the upper side of the pump 12.

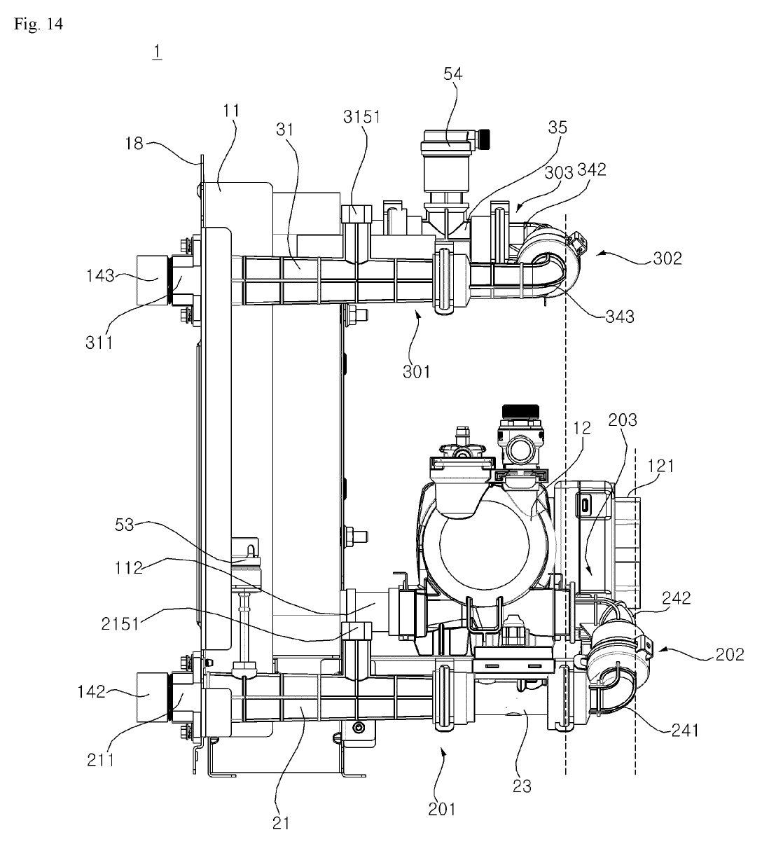

The front portion of the water outlet pipe assembly 3 may be arranged rearward with respect to the front portion of the water inlet pipe assembly 2 (see FIG. 14). That is, a space may be formed between the front portion of the water outlet pipe assembly 2 and the front panel 83.

The refrigerant inflow pipe 72 may be arranged between the front portion of the water outlet pipe assembly 3 and the front panel 83 in the front-rear direction.

A sensor coupling portion 726, 728 to which a refrigerant sensor 725, 727 is coupled may be welded to the refrigerant inflow pipe 72. For example, a temperature sensor coupling portion 726 to which a temperature sensor 725 is coupled may be welded to the refrigerant inflow pipe 72. A pressure sensor coupling portion 728 to which a pressure sensor 727 is coupled may be welded to the refrigerant inflow pipe 72. The temperature sensor 725 and the pressure sensor 727 may be arranged between the front portion of the water outlet pipe assembly 3 and the front panel 83.

The expansion tank 13 and the pump 12 may be connected by a connecting hose 132. When the temperature and/or pressure of the water inlet pipe assembly 2 increases, water is discharged from the pump 12 to the expansion tank 13. When the temperature and/or pressure of the water inlet pipe assembly 2 decreases, water may flow from the expansion tank 13 to the pump 12.

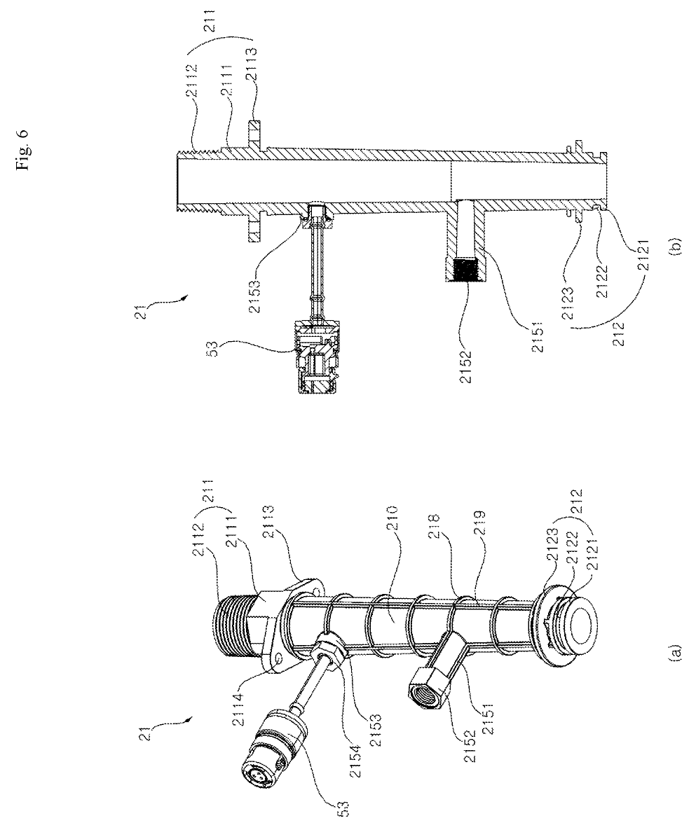

Hereinafter, the water pipe 2, 3 will be described with reference to FIGS. 6 to 11. (a) of each drawing is a perspective view, and (b) is a cross-sectional view.

The water pipe 2, 3 includes a plurality of injection molded pipes 21, 31, 35, 41, 42, 43, 44. The plurality of injection molded pipes 21, 31, 35, 41, 42, 43, 44 may be coupled to form the water inlet pipe assembly 2 and/or the water outlet pipe assembly 3.

Each of the plurality of injection molded pipes 21, 31, 35, 41, 42, 43, 44 may include a pipe coupling portion that connects to other injection molded pipe.

The pipe coupling portion may include a male coupling portion that is inserted into the pipe coupling portion of other pipe and/or a female coupling portion that receives the male coupling portion of other injection molded pipe.

The injection molded pipe 21, 31, 35, 41, 42, 43, 44 may be made of an engineering plastic. The injection molded pipe 21, 31, 35, 41, 42, 43, 44 may be made of an engineering plastic that has relatively high strength, heat resistance, and melting point compared to plastics commonly used in daily life, such as PE. For example, the injection molded pipe 21, 31, 35, 41, 42, 43, 44 may be made of polyamide 66 (PA66). The injection molded pipe 21, 31, 35, 41, 42, 43, 44 may be manufactured by injection molding PA66.

The injection molded pipes 21, 31, 35, 41, 42, 43, 44 may have different shapes.

The injection molded pipe 21 illustrated in FIG. 6 is referred to as a water inlet pipe 21. Referring to FIG. 6, the water inlet pipe 21 may include a water inlet pipe body 210. The water inlet pipe body 210 may extend in one direction. That is, the water inlet pipe body 210 may extend in a straight line without bending.

The water inlet pipe body 210 may be cylindrical. The water inlet pipe body 210 may have a hollow truncated cone shape with one end having a smaller diameter than the other end.

The water inlet pipe 21 may include a port coupling portion 211. The port coupling portion 211 may be arranged on one side of the water inlet pipe body 210. The port coupling portion 211 may extend parallel to the water inlet pipe body 210.

The port coupling portion 211 may pass through the support panel 18 (see FIG. 4) in a direction from the inside of the machine compartment 81 (see FIG. 3) to the outside and be arranged at the rear of the support panel 18.

The port coupling portion 211 may include a head 2111 and a thread 2112. The head 2111 may be arranged on the water inlet pipe body 210 side, and the thread 2112 may extend to the opposite side of the water inlet pipe body 210 with respect to the head 2111.

A screw thread may be formed on the outer circumference of the thread 2112. The inlet port 142 may be coupled to the thread 2112. Alternatively, an external pipe may be coupled to the thread 2112.

The head 2111 may have an angular shape. For example, the head 2111 may have a hexagonal or octagonal outer circumference. When the thread 2112 is coupled to the inlet port 142 or an external pipe, the water inlet pipe 21 may be fixed by using a tool such as a spanner.

The water inlet pipe 21 may include a mount 2113 extending radially outward between the head 2111 and the water inlet pipe body 210.

The mount 2113 may be arranged at the rear of the support panel 18 by passing through the support panel 18 (see FIG. 4) from the inside of the machine compartment 81 (see FIG. 3) toward the outside.

A fastening hole 2114 may be formed in the mount 2113. The mount 2113 may be coupled to the support panel 18 at the rear of the support panel 18 through a separate fastening member, such as a screw, passing through the fastening hole 2114.

The water inlet pipe 21 may include a male coupling portion 212. The male coupling portion 212 may be arranged at the other side of the water inlet pipe body 210. The male coupling portion 212 may extend parallel to the water inlet pipe body 210. The male coupling portion 212 may be arranged on the opposite side of the port coupling portion 211.

The male coupling portion 212 may include a coupling body 2121 extending parallel to the water inlet pipe body 210. The coupling body 2121 may be inserted into a female coupling portion of other injection molded pipe.

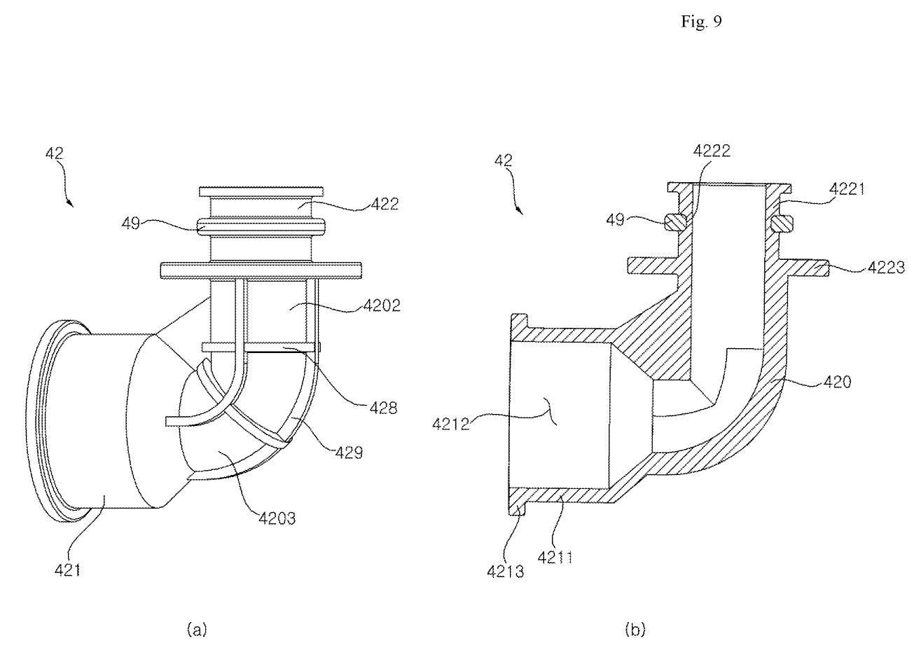

A ring-shaped groove 2122 that is recessed inward may be formed on the outer circumferential surface of the coupling body 2121. A ring-shaped gasket 49 (see FIG. 9) may be accommodated in the groove 2122. The cross-sectional diameter of the gasket 49 inserted into the groove 2122 may be larger than the depth of the groove 2122. Accordingly, the male coupling portion 212 may be sealed to prevent water leakage when inserted into the female coupling portion of other injection molded pipe.

The male coupling portion 212 may include a flange 2123. The flange 2123 may be located on the water inlet pipe body 210 side. The distance from the flange 2123 to the end of the male coupling portion 212 may be the same as the depth of the groove of the female coupling portion of other injection molded pipe.

The water inlet pipe 21 may include a temperature sensor coupling portion 2151. The temperature sensor coupling portion 2151 may extend radially from the water inlet pipe body 210. The temperature sensor coupling portion 2151 may have a hollow portion communicating with the internal flow path of the water inlet pipe body 210.

The first temperature sensor 51 may be coupled to the temperature sensor coupling portion 2151. A nut portion 2152 may be provided at a distal end (a radially outer end of the water inlet pipe body) of the temperature sensor coupling portion 2151. The outer circumference of the nut portion 2152 may be angled, and a screw thread may be formed on the inner circumference. The first temperature sensor 51 may be coupled to the screw thread of the nut portion 2152.

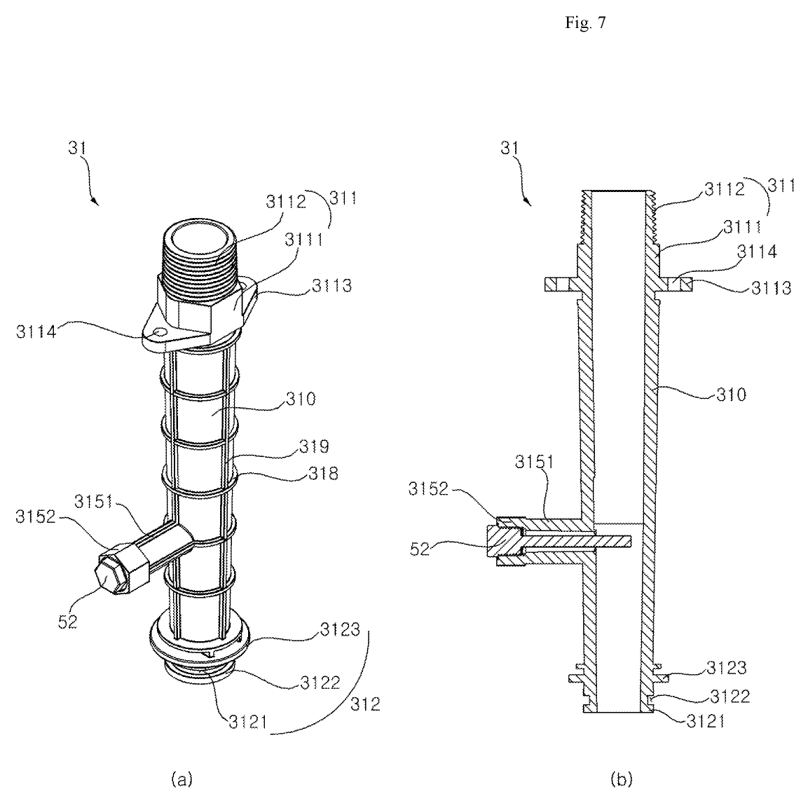

When the first temperature sensor 51 is coupled to the temperature sensor coupling portion 2151, the distal end of the first temperature sensor 51 may be located within the internal flow path of the water inlet pipe body 210 (see the second temperature sensor 52 and the water outlet pipe 31 of FIG. 7).

A ring-shaped reinforcing rib 218 and a longitudinally extending reinforcing rib 219 may be provided on the outer circumference of the water inlet pipe body 210. The reinforcing rib 218, 219 may protrude from the outer circumference of the water inlet pipe body 210. There may be provided a plurality of reinforcing ribs 218, 219.

The injection molded pipe 31 illustrated in FIG. 7 is referred to as a water outlet pipe 31. Referring to FIG. 7, the water outlet pipe 31 differs from the water inlet pipe 21 in that the pressure sensor coupling portion 2153 is not formed, and otherwise has the same shape as the water inlet pipe 21. Therefore, the shape of the water outlet pipe 31 is briefly described.

The water outlet pipe 31 may include a water outlet pipe body 310. The water outlet pipe body 310 may have the same shape as the water inlet pipe body 510.

The water outlet pipe 31 may include a port coupling portion 311. The port coupling portion 311 of the water outlet pipe 31 has the same shape as the port coupling portion 211 of the water inlet pipe 21. The port coupling portion 311 may pass through the support panel 18 (see FIG. 4) in a direction from the inside of the machine compartment 81 (see FIG. 3) toward the outside and be arranged at the rear of the support panel 18. The port coupling portion 311 may include a head 3111 and a thread 3112.

The discharge port 143 may be coupled to the thread 3112. Alternatively, an external pipe may be coupled to the thread 3112.

When the thread 3112 is coupled to the discharge port 143 or an external pipe, the water outlet pipe 31 may be fixed by using a tool such as a spanner.

The water outlet pipe 31 may include a mount 3113.

The mount 3113 may be arranged at the rear of the support panel 18 by passing through the support panel 18 (see FIG. 4) from the inside of the machine compartment 81 (see FIG. 3) toward the outside.

A fastening hole 3114 may be formed in the mount 3113. The mount 3113 may be coupled to the support panel 18 at the rear of the support panel 18 through a separate fastening member, such as a screw, passing through the fastening hole 3114.

The water outlet pipe 31 may include the male coupling portion 312. The male coupling portion 312 may include a coupling body 3121. A ring-shaped groove 3122 that is recessed inward may be formed on the outer circumferential surface of the male coupling portion 3121. A ring-shaped gasket 49 may be accommodated in the groove 3122. The gasket 49 may be made of an elastic material. The cross-sectional diameter of the gasket 49 inserted into the groove 3122 may be larger than the depth of the groove 3122. Accordingly, the male coupling portion 312 may be sealed to prevent water leakage when inserted into the female coupling portion of other injection molded pipe.

The male coupling portion 312 may include a flange 3123.

The water outlet pipe 31 may include a temperature sensor coupling portion 3151. The temperature sensor coupling portion 3151 may extend radially from the water outlet pipe body 310. The temperature sensor coupling portion 3151 may have a hollow portion communicating with the internal flow path of the water outlet pipe body 310.

The second temperature sensor 52 may be coupled to the temperature sensor coupling portion 3151. A nut portion 3152 may be provided at a distal end (a radially outer end of the water inlet pipe body) of the temperature sensor coupling portion 3151. The second temperature sensor 52 may be coupled to the screw thread of the nut portion 3152.

When the second temperature sensor 52 is coupled to the temperature sensor coupling portion 3151, the distal end of the second temperature sensor 52 may be arranged in the internal flow path of the water outlet pipe body 310.

The water outlet pipe 310 may include a ring-shaped reinforcing rib 318 and a longitudinally extending reinforcing rib 319.

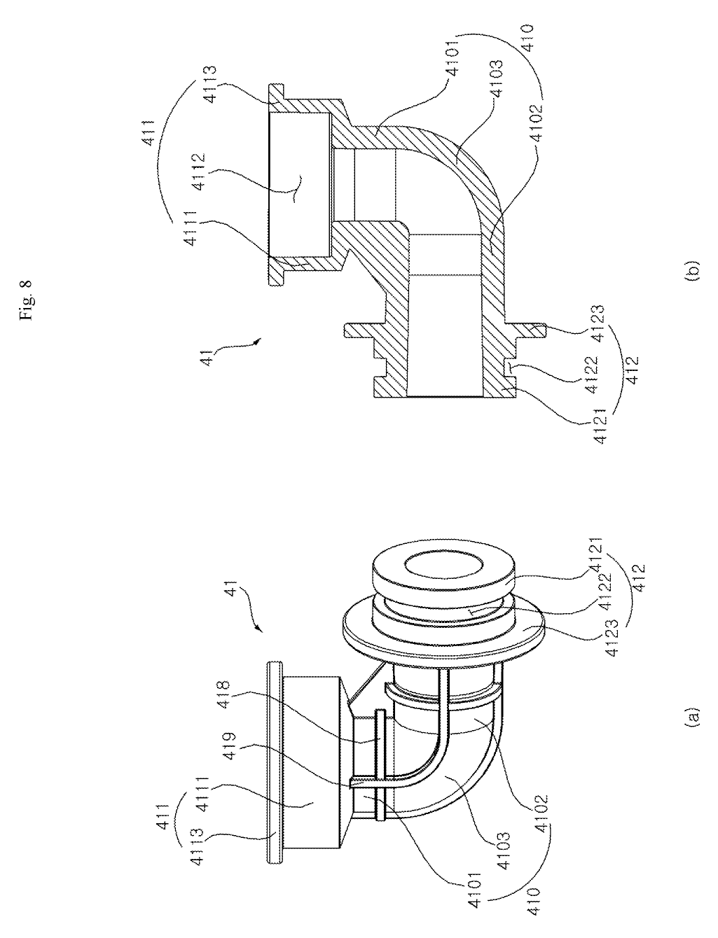

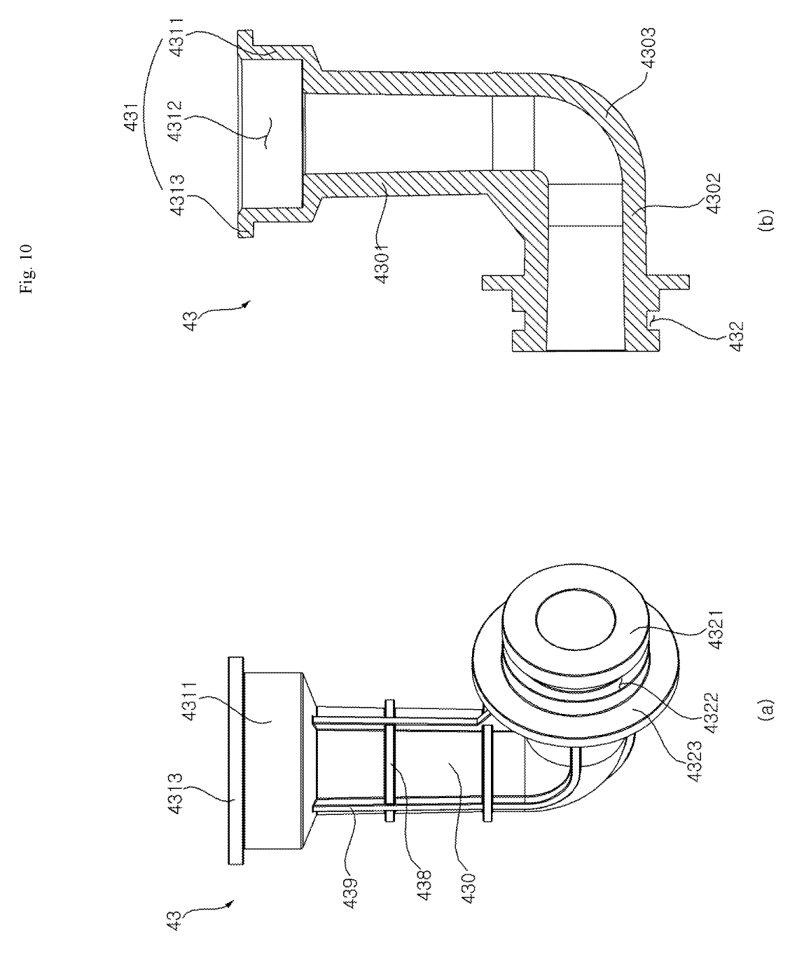

The injection molded pipe 41, 42, 43 illustrated in FIGS. 8 to 10 is referred to as a connecting pipe 41, 42, 43. The connecting pipe 41 illustrated in FIG. 8 is referred to as a first connecting pipe 41, the connecting pipe 42 illustrated in FIG. 9 is referred to as a second connecting pipe 42, and the connecting pipe 43 illustrated in FIG. 10 is referred to as a third connecting pipe 43.

Referring to FIGS. 8 to 10, the connecting pipe 41, 42, 43 may include a connecting pipe body 410, 420, 430. The connecting pipe body 410, 420, 430 may be hollow.

The connecting pipe body 410, 420, 430 may be bent. The connecting pipe body 410 may include a curved pipe portion 4103, 4203, 4303 extending in an arc shape. The central angle of the curved pipe portion 4103, 4203, 4303 may be 90 degrees.

The radius of curvature of the curved pipe portion 4103, 4203, 4303 may be approximately equal to the diameter of the connecting pipe body 410, 420, 430.

The radial cross-section of the connecting pipe body 410, 420, 430 may be ring-shaped. The connecting pipe body 410, 420, 430 may have a shape of a hollow cylinder bent at a 90 degree angle.

The connecting pipe 410, 420, 430 may include a female coupling portion 411, 421, 431. The female coupling portions 411, 421, 431 may be arranged on one side of the connecting pipe body 410, 420, 430. The female coupling portions 411, 421, 431 may extend parallel to one end of the connecting pipe body 410, 420, 430.

The female coupling portion 411, 421, 431 may include a circumferential portion 4111, 4211, 4311 having a larger diameter than the connecting pipe body 410, 420, 430. The circumferential portions 4111, 4211, 4311 may surround the connecting body of the male coupling portion of the injection molded pipe.

The female coupling portions 411, 421, 431 may include an accommodating portion 4112, 4212, 4312 arranged on the inner side of the circumferential portion 4111, 4211, 4311. A coupling body of the male coupling portion of the injection molded pipe may be inserted into the accommodating portion 4112, 4212, 4312.

The inner diameter of the female coupling portion 411, 421, 431, i.e., the diameter of the accommodating portion 4112, 4212, 4312, may be greater than or equal to the outer diameter of the coupling body of the male coupling portion of the injection molded pipe. The diameter of the accommodating portion 4112, 4212, 4312 may be greater than the outer diameter of the coupling body of the male coupling portion of the injection molded pipe, and may be smaller than the outer diameter of the gasket 49 inserted into a groove of the coupling body. Accordingly, when the coupling body is inserted into the female coupling portion, the gasket 49 may be compressed and inserted to seal a space between the male coupling portion and the female coupling portion.

The female coupling portion 411, 421, 431 may include a flange 4113, 4213, 4313. The flange 4113, 4213, 4313 may be located at the longitudinal outer end of the circumferential portion 4111, 4211, 4311. The diameter of the flange 4113, 4213, 4313 may be larger than that of the circumferential portion 4111, 4211, 4311. The flange 4113, 4213, 4313 may extend radially outward from the outer end of the circumferential portion 4111, 4211, 4311.

The diameter of the flange 4113, 4213, 4313 of the female coupling portion 411, 421, 431 may be the same as the diameter of the flange of the male coupling portion of the injection molded pipe.

The depth of the accommodating portion 4112, 4212, 4312 may be the same as the length of the coupling body of the male coupling portion.

The connecting pipe 41, 42, 43 may include the male coupling portion 412, 422, 432. The male coupling portion 412, 422, 432 may be arranged on the other side of the connecting pipe body 410, 420, 430. The male coupling portion 412, 422, 432 may extend parallel to the other end of the connecting pipe body 410, 420, 430. The male coupling portion 412, 422, 432 may be located on the opposite side of the female coupling portion 411, 421, 431.

The male coupling portion 412, 422, 432 of the connecting pipe 41, 42, 43 may have the same shape as the male coupling portion 212 of the water inlet pipe 21.

A coupling body 4121, 4221, 4321 may extend parallel to the other end of the connecting pipe body 210. The coupling body 4121, 4221, 4321 may be inserted into the female coupling portion.

A ring-shaped groove 4122, 4222, 4322 that is recessed inwardly may be formed on the outer circumferential surface of the coupling body 4121, 4221, 4321, and a ring-shaped gasket 49 may be accommodated in the groove 4122, 4222, 4322.

The cross-sectional diameter of the gasket 49 inserted into the groove 4122, 4222, 4322 may be larger than the depth of the groove 4122, 4222, 4322.

The male coupling portion 412, 422, 432 may include a flange 4123, 4223, 4323.

The outer circumference of the connecting pipe body 410, 420, 430 may be provided with a ring-shaped reinforcing rib 418, 428, 438 and a longitudinally extending reinforcing rib 419, 428, 439.

Referring to FIG. 8, the connecting body 410 of the first connecting pipe 41 may include a first straight pipe portion 4101 extending between the curved pipe portion 4103 and the female coupling portion 411.

The first straight pipe portion 4101 may have a cylindrical shape. The first straight pipe portion 4101 may extend parallel to one end of the curved pipe portion 4103.

The female coupling portion 411 may extend parallel to the first straight pipe portion 4101.

The connecting body 410 of the first connecting pipe 41 may include a second straight pipe portion 4102 extending between the curved pipe portion 4103 and the male coupling portion 412. The second straight pipe portion 4102 may have a cylindrical shape. The second straight pipe portion 4102 may extend parallel to the other end of the curved pipe portion 4103. The male coupling portion 412 may extend parallel to the second straight pipe portion 4102.

The second straight pipe portion 4102 may be longer than the first straight pipe portion 4101.

Referring to FIG. 9, a curved pipe portion 4203 of the second connecting pipe may meet the female coupling portion 421. The female coupling portion 421 may extend parallel to one end of the curved pipe portion 4203.

The connecting body 420 of a second connecting pipe 42 may include a straight pipe portion 4202 extending between the curved pipe portion 4203 and the female coupling portion 422. The straight pipe portion 4202 may have a cylindrical shape. The straight pipe portion 4202 may extend parallel to the other end of the curved pipe portion 4203. The female coupling portion 422 may extend parallel to the straight pipe portion 4202.

The straight pipe portion 4202 of the second connecting pipe may be longer than the second straight pipe portion 4102 of the first connecting pipe.

Referring to FIG. 10, the connecting body 430 of the third connecting pipe 43 may include a first straight pipe portion 4301 extending between the curved pipe portion 4303 and the female coupling portion 431. The first straight pipe portion 4301 may be cylindrical. The first straight pipe portion 4301 may extend parallel to one end of the curved pipe portion 4303. The female coupling portion 431 may extend parallel to the first straight pipe portion 4301.

The connecting body 430 of the third connecting pipe 41 may include a second straight pipe portion 4302 extending between the curved pipe portion 4303 and the male coupling portion 432.

The second straight pipe portion 4302 may be cylindrical.

The second straight pipe portion 4302 may extend parallel to the other end of the curved pipe portion 4303.

The male coupling portion 432 may extend parallel to the second straight pipe portion 4302.

The first straight pipe portion 4301 may be longer than the second straight pipe portion 4302.

The first straight pipe portion 4301 of the third connecting pipe 43 may be longer than the first straight pipe portion 4101 of the first connecting pipe 41. The second straight pipe portion 4302 of the third connecting pipe 43 and the second straight pipe portion 4102 of the first connecting pipe 41 may have the same length.

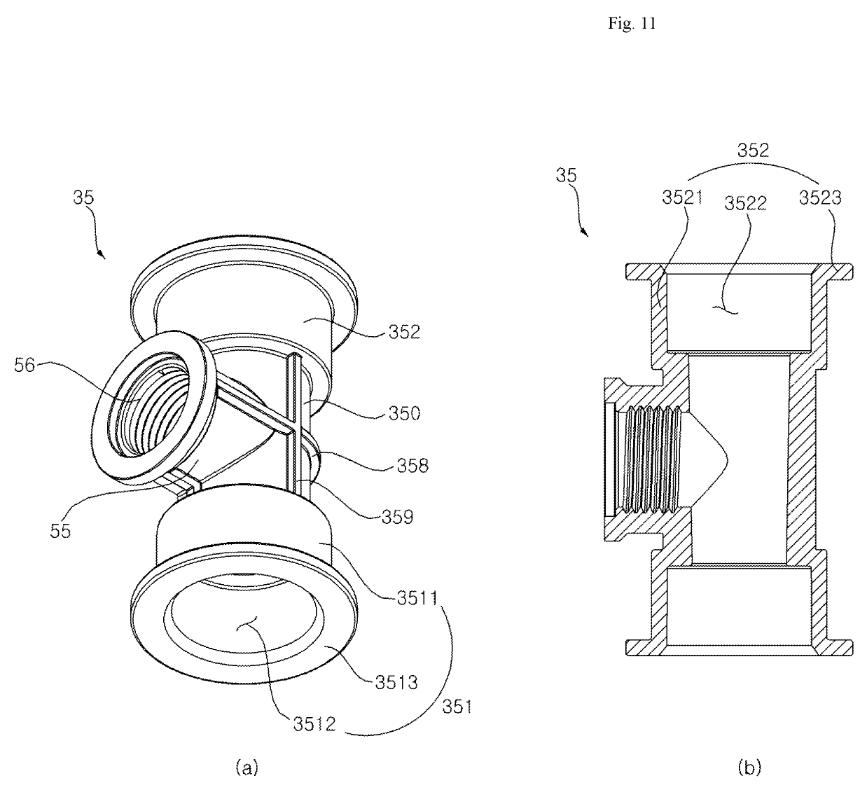

The injection molded pipe 35 illustrated in FIG. 11 is referred to as a branch pipe 35. Referring to FIG. 11, the branch pipe 35 includes a branch pipe body 350. The branch pipe body 350 may extend in one direction. That is, the branch pipe body 350 may extend in a straight line without bending.

The branch pipe body 350 may be cylindrical. The branch pipe body 350 may have a hollow portion.

The branch pipe 35 may include a first female coupling portion 351. The first female coupling portion 351 may be arranged on one side of the branch pipe body 350. The first female coupling portion 351 may extend parallel to the branch pipe body 350.

The first female coupling portion 351 may include a circumferential portion 3511 having a larger diameter than the branch pipe body 350. The circumferential portion 3511 may surround the coupling body of the male coupling portion of the injection molded pipe.

The first female coupling portion 351 may include an accommodating portion 3512 arranged inside the circumferential portion 3511. The coupling body of the male coupling portion of the injection molded pipe may be inserted into the accommodating portion 3512.

The inner diameter of the first female coupling portion 351, i.e., the diameter of the accommodating portion 3512, may be greater than or equal to the outer diameter of the coupling body of the male coupling portion of the injection molded pipe. The diameter of the accommodating portion 3512 may be greater than the outer diameter of the coupling body of the male coupling portion of the injection molded pipe, and may be smaller than the outer diameter of the gasket 49 inserted into the groove of the coupling body.

Therefore, when the coupling body is inserted into the female coupling portion, the gasket 49 may be compressed and inserted, thereby sealing a space between the male coupling portion and the female coupling portion.

The first female coupling portion 351 may include a flange 3513. The flange 3513 may be located at the longitudinal outer end of the circumferential portion 3511. The diameter of the flange 3513 may be greater than that of the circumferential portion 3511. The flange 3513 may extend radially outward from the outer end of the circumferential portion 3511.

The diameter of the flange 3513 of the first female coupling portion 351 may be the same as the diameter of the flange of the male coupling portion of the injection molded pipe.

The depth of the accommodating portion 3512 may be the same as the length of the coupling body of the male coupling portion coupled to the first female coupling portion 351.

The branch pipe 35 may include a second female coupling portion 352. The second female coupling portion 352 may be arranged on the other side of the branch pipe body 350. The second female coupling portion 352 may extend parallel to the branch pipe body 350. The second female coupling portion 352 may have the same shape and be symmetrical with the first female coupling portion 351.

The second female coupling portion 352 may include a circumferential portion 3521, an accommodating portion 3522, and a flange 3523.

The second female coupling portion 352 may be connected to the water outlet port 113 of the first heat exchanger 11.

The branch pipe 35 may include an air vent coupling portion 355. The air vent coupling portion 355 may extend radially from the branch pipe body 350. The air vent coupling portion 355 may have a hollow portion communicating with the internal flow path of the branch pipe 35. The internal flow path of the branch pipe 35 may be branched to the air vent coupling portion 355.

An air vent 54 may be coupled to the air vent coupling portion 355. The air vent coupling portion 355 may have a screw thread 356 formed on its inner circumference.

The air vent 355 has a male screw shape and may be connected to the air vent coupling portion 355.

The air vent 355 may discharge the gas within the flow path of the water pipe module 1 to the outside.

A first reinforcing rib 358 extending in a circumferential direction and a second reinforcing rib 359 extending in a length direction of the branch pipe body 35 may protrude from the outer surface of the branch pipe body 35.

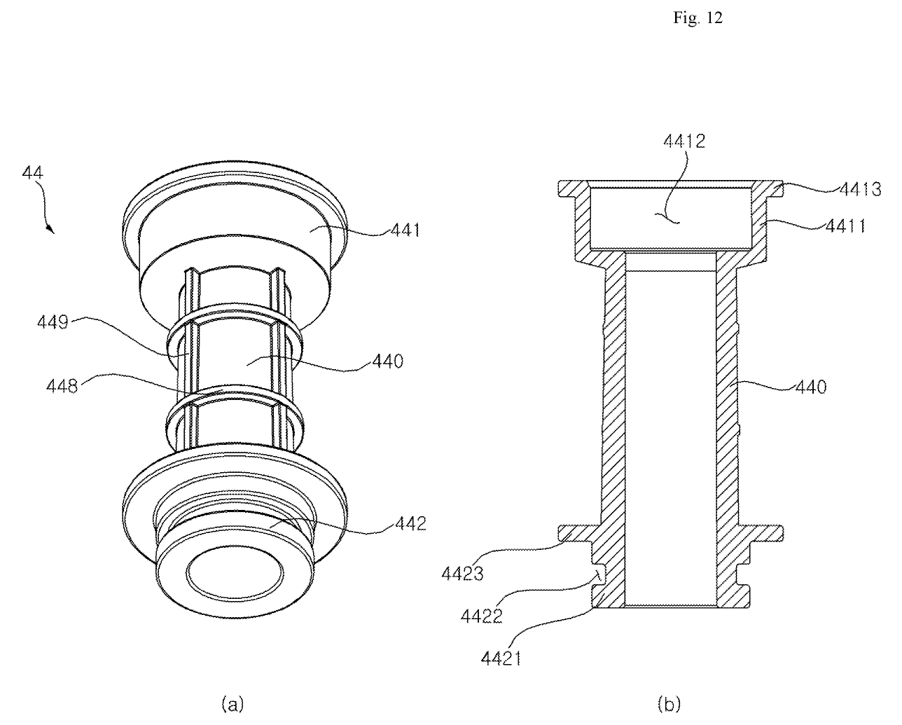

The injection molded pipe 44 illustrated in FIG. 12 is referred to as an extension pipe 44. Referring to FIG. 12, the extension pipe 44 may include an extension pipe body 440. The extension pipe body 440 may extend in one direction. That is, the extension pipe body 440 may extend in a straight line without bending.

The extension pipe body 440 may be cylindrical. The extension pipe body 440 may have a hollow truncated cone shape with one end having a smaller diameter than the other end. The extension pipe body 440 may have a diameter on the female coupling portion 442 side smaller than the diameter on the male coupling portion 441 side.

The extension pipe 44 may include a female coupling portion 441. The female coupling portion 441 may be arranged on one side of the extension pipe body 440. The female coupling portion 441 may extend parallel to the extension pipe body 440.

The female coupling portion 441 may include a circumferential portion 4411 having a larger diameter than the extension pipe body 440. The circumferential portion 4411 may surround the coupling body of the male coupling portion of the injection molded pipe coupled to the female coupling portion 441.

The female coupling portion 441 may include an accommodating portion 4412 arranged on the inner side of the circumferential portion 4411. The coupling body of the male coupling portion coupled to the female coupling portion 441 may be inserted into the accommodating portion 4412.

The inner diameter of the female coupling portion 441, i.e., the diameter of the accommodating portion 4412, may be greater than or equal to the outer diameter of the coupling body of the male coupling portion coupled to the female coupling portion. The diameter of the accommodating portion 4412 may be greater than the outer diameter of the coupling body of the male coupling portion coupled to the female coupling portion, and may be smaller than the outer diameter of the gasket 49 inserted into the groove of the coupling body.

Accordingly, when the coupling body is inserted into the female coupling portion, the gasket 49 may be compressed and inserted to seal the space between the male coupling portion and the female coupling portion.

The female coupling portion 441 may include a flange 4413. The flange 4413 may be located at the longitudinal outer end of the circumferential portion 4113. The diameter of the flange 4413 may be larger than the diameter of the circumferential portion 4113. The flange 4413 may extend radially outward from the outer end of the circumferential portion 4413.

The diameter of the flange 4413 of the female coupling portion 441 may be equal to the diameter of the flange of the male coupling portion of the injection molded pipe coupled to the female coupling portion 441.

The depth of the accommodating portion 4412 may be equal to the length of the coupling body of the male coupling portion coupled to the female coupling portion 441.

The extension pipe 44 may include a male coupling portion 442. The male coupling portion 442 may be arranged on the other side of the connecting pipe body 440. The male coupling portion 442 may extend in the length direction of the connecting pipe body 440. The male coupling portion 442 may be arranged on the opposite side of the female coupling portion 441.

The male coupling portion 442 of the extension pipe 44 may have the same shape as the male coupling portion 212 of the water inlet pipe 21.

The coupling body 442 may extend in the length direction of the extension pipe body 440. The coupling body 4121, 4221, 4321 may be inserted into the female coupling portion of the injection molded pipe coupled to the male coupling portion 442.

A ring-shaped groove 4422 that is recessed inwardly may be formed on the outer circumferential surface of the coupling body 442, and a ring-shaped gasket 49 may be accommodated in the groove 4422. The cross-sectional diameter of the gasket 49 inserted into the groove 4422 may be larger than the depth of the groove 4422.

The male coupling portion 442 may include a flange 4423.

A ring-shaped reinforcing rib 448 and a second reinforcing rib 449 extending in the length direction may protrude from the outer circumference of the extension pipe body 440.

Hereinafter, a water pipe module 1 according to a first embodiment of the present disclosure will be described with reference to FIGS. 13 and 14.

Referring to FIGS. 13 and 14, the water pipe module 1 may receive water from the outside, heat the water, and supply the heated water to the outside.

Water flowing into the water pipe module 1 from the outside may flow into the water inlet pipe assembly 2 through the inlet port 142. The water flowing into the water inlet pipe assembly 2 may be flowed into the heat exchanger 11 by the pump 12. The water flowing into the heat exchanger 11 may be heated by absorbing heat from the refrigerant. The water discharged from the heat exchanger 11 may flow along the water outlet pipe assembly 3. The water in the water outlet pipe assembly 3 may be supplied to the outside through the discharge port 143.

The water supplied to the discharge port 143 may flow into the inlet port 142 through an external circulation flow path. A portion of the water supplied to the discharge port 143 may be used externally, and the remaining portion may flow into the inlet port 142.

Water may flow into the inlet port 142 from an external water source, such as a tap. That is, water newly supplied from the external water source and water circulated through an external water circulation system may both flow into the inlet port 142.

The water pipe module 1 may include a water inlet pipe assembly 2, a pump 12, a heat exchanger 11, and a water outlet pipe assembly 3.

The water inlet pipe assembly 2 may include multiple injection molded pipes 21, 232, 241, 242. The multiple injection molded pipes may be connected by the aforementioned male and female coupling portions. The connected multiple injection molded pipes may be fixed by a clamp 29. The water inlet pipe assembly 2 may be connected to the pump 12 and fixed by a clamp 294.

The water inlet pipe assembly 2 extends forward from a lower side than the pump 12, and may be connected to the water inlet end of the pump 12 by bending upward and rearward from a position forward of the pump 12.

The water inlet pipe assembly 2 may include a water inlet pipe 21. The water inlet pipe 21 includes a port coupling portion 211. The port coupling portion 211 is coupled to the inlet port 142.

The water inlet pipe 21 may penetrate the support panel 18. The water inlet pipe 21 penetrates the support panel 18 and the rear panel 84 (see FIG. 3), and may be connected to an external water pipe through the inlet port 142 outside the casing 8.

The pressure sensor 53 and the first temperature sensor 51 may be coupled to the water inlet pipe 21. The pressure sensor 53 may measure the pressure of water flowing into the water pipe module 1 from the outside. The first temperature sensor 51 may measure the temperature of water flowing into the water pipe module 1 from the outside.

A pressure sensor installation portion 2153 and a temperature sensor installation portion 2151 may be molded as one body when the water inlet pipe 21 is injection molded. The water inlet pipe 21 may be injection molded from PA66. The other injection molded pipes of the water inlet pipe assembly 2 may also be injection molded from PA66.

This enables the pressure sensor and temperature sensor to be easily installed in the water inlet pipe 21. Furthermore, even after the product is installed at the intended location, the pressure sensor and the temperature sensor may be detached from their respective installation portions for repair, maintenance, and replacement.

The water inlet pipe assembly 23 may include the flow meter 23. The water inlet pipe 21 may be coupled to the flow meter 23. The flow meter 23 may include a pipe portion 232 which is coupled to the water inlet pipe 21 and through which water flows. The pipe portion 232 may extend in the length direction of the water inlet pipe 21. The pipe portion 232 may be arranged on a straight line in the length direction of the water inlet pipe 21.

The pipe portion 232 may have a female coupling portion at one end. The female coupling portion of the pipe portion 232 may have the same shape as at least one of the female coupling portions 411, 421, 431, 441, 351 of the aforementioned connecting portion 41, 42, 43, extension portion 44, or branch pipe 35.

The male coupling portion 212 (see FIG. 6) of the water inlet pipe 21 may be inserted into the female coupling portion of the pipe portion 232. The coupling body 2121 (see FIG. 6) of the male coupling portion 212 is inserted into the female coupling portion of the pipe portion 232, and the gasket 49 (see FIG. 9) arranged in the groove 2122 (see FIG. 6) may seal the space between the female coupling portion and the male coupling portion 212 of the pipe portion 232.

After the water inlet pipe 21 and the pipe portion 232 of the flow meter 23 are inserted and coupled, the flange 2123 (see FIG. 6) of the water inlet pipe 21 and the flange of the pipe portion 232 may be firmly coupled through the clamp 291.

The pipe portion 232 may be made of plastic. The pipe portion 232 may be made of engineering plastic. For example, the pipe portion 232 may be formed by injection molding from PA66. Alternatively, the pipe portion may be made of SUS.

The water inlet pipe assembly 2 may include a water inlet connecting pipe 24. One end of the water inlet connecting pipe 24 may be connected to the water inlet pipe 21, and the other end may be connected to the pump 12.

One end of the water inlet connecting pipe 24 may be connected to the pipe portion 232 of the flow meter 23. The other end of the water inlet connecting pipe 24 may be connected to the inlet of the pump 12.

The water inlet connecting pipe 24 may include a first coupling portion 411 (see FIG. 8) connected to the water inlet pipe 21 and a second coupling portion 422 (see FIG. 9) connected to the pump 12.

One end of the water inlet connecting pipe 24, i.e., the first coupling portion 411, may be connected to the pipe portion 232 of the flow meter 23. The other end of the water inlet connecting pipe 24, i.e., the second coupling portion 422, may be connected to the inlet of the pump 12.

The water inlet connecting pipe 24 is arranged forward of the water inlet pipe 21 and the pump 12, and the first coupling portion 411 and the second coupling portion 422 may face rearward.

The water inlet connecting pipe 24 may include a straight pipe portion and a curved pipe portion. The water inlet connecting pipe 24 may include at least one straight pipe portion and at least one curved pipe portion.

The water inlet connecting pipe 24 may include a first water inlet curved pipe portion 4103 (see FIG. 8) arranged on the water inlet pipe 21 side. The water inlet connecting pipe 24 may include a second water inlet curved pipe portion 4203 arranged on the pump 12 side.

The first water inlet curved pipe portion 4103 may be bent from the first coupling portion 411 in a direction intersecting with the water inlet pipe 21. The first water inlet curved pipe portion 4103 may be bent from the first coupling portion 411 in a direction perpendicular to the water inlet pipe 21.

A first water inlet straight pipe portion 4101 may be arranged between the first water inlet curved pipe portion 4103 and the first coupling portion 411. The first water inlet straight pipe portion 4101 may be arranged parallel to the water inlet pipe 21.

A second water inlet straight pipe portion 4202 may be arranged between the second water inlet curved pipe portion 4203 and the second coupling portion 422. The second water inlet straight pipe portion 4202 may extend toward the pump 12. The second water inlet straight pipe portion 4202 may be parallel to the first water inlet straight pipe portion 4101.

The second water inlet curved pipe portion 4203 may be bent from the second water inlet straight pipe 422 in a direction intersecting with the second water inlet straight pipe 422. The second water inlet curved pipe portion 4203 may be bent in a direction perpendicular to the second water inlet straight pipe 422.

The straight pipe portion 4102, 4201 may be arranged between the first water inlet curved pipe portion 4103 and the second water inlet curved pipe portion 4203. A third water inlet straight pipe portion 4102 may extend from the first water inlet curved pipe portion 4103. A fourth water inlet straight pipe portion 4201 may extend from the second water inlet curved pipe portion 4203. The third and fourth water inlet straight pipe portions 4102, 4201 may be arranged in a straight line.

The third and fourth water inlet straight pipe portions 4102, 4201 may be connected to each other. A third coupling portion 412 may be provided at the distal end of the third water inlet straight pipe portion 4102, a fourth coupling portion 421 may be provided at the distal end of the fourth water inlet straight pipe portion 4201, and the third and fourth coupling portions 412, 421 may be connected to each other.

The water inlet pipe assembly 2 may include the first connecting pipe 41. Hereinafter, the first connecting pipe 41 of the water inlet pipe assembly is also referred to as a first water inlet connecting pipe 241. The water inlet connecting pipe 24 may include the first water inlet connecting pipe 241.

The pipe portion 232 of the flow meter 23 may be connected to the first water inlet connecting pipe 241. The pipe portion 232 may have a male coupling portion on the first water inlet connecting pipe 241 side, and the male coupling portion may be connected to the first water inlet connecting pipe 241.

The male coupling portion of the pipe portion 232 may be connected to the female coupling portion 411 (see FIG. 8) of the first water inlet connecting pipe 241. The male coupling portion of the pipe portion 232 may have the same structure as at least one of the male coupling portions of the aforementioned injection molded pipes.

The connecting body of the pipe portion is inserted into the female connecting portion 411 of the first water inlet connecting pipe 241, and the gasket 49 may seal the space between the connecting body of the pipe portion and the female connecting portion 411.

The flange 4123 of the first water inlet connecting pipe 241 and the flange of the flow meter pipe portion 232 may be connected through the clamp 292.

In the first water inlet connecting pipe 241, the first straight pipe portion 4101 is arranged in the front-rear direction, and the curved pipe portion is bent 90 degrees at between the first and second straight pipe portions 4101, 4102, so that the second straight pipe portion 4102 and the male coupling portion 412 may face in a direction excluding the front-rear direction.

The second straight pipe portion 4102 and the male coupling portion 412 may face the pump 12. The second straight pipe portion 4102 and the male coupling portion 412 may face the opposite side and upper side of the heat exchange compartment 87.

The water inlet pipe assembly 2 may include the second connecting pipe 42. Hereinafter, the second connecting pipe 42 of the water inlet pipe assembly is also referred to as a second water inlet connecting pipe 242. The water inlet connecting pipe 24 may include the second water inlet connecting pipe 242.

The female coupling portion 421 of the second water inlet connecting pipe 242 may be arranged parallel to the second straight pipe portion 4102 and the male coupling portion 412 of the first water inlet connecting pipe 241. The female coupling portion 421 of the second water inlet connecting pipe 242 may be coupled to the male coupling portion 412 of the first water inlet connecting pipe 241.

The coupling body 4121 of the first water inlet connecting pipe 241 is inserted into the accommodating portion 4212 of the second water inlet connecting pipe 242, and the gasket 49 may seal the male coupling portion 412 of the first water inlet connecting pipe 241 and the female coupling portion 421 of the second water inlet connecting pipe 242.

The flange 4123 of the male coupling portion 412 of the first water inlet connecting pipe 241 and the flange 4213 of the female coupling portion 421 of the second water inlet connecting pipe 242 may be coupled through the clamp 293.

The second water inlet connecting pipe 242 has a curved pipe portion 4203 arranged between the female coupling portion 421 and the straight pipe portion 4202, so that the straight pipe portion 4202 and the male coupling portion 422 may be arranged in a different direction from the second straight pipe portion 4102 and the male coupling portion 412 of the first water inlet connecting pipe 241.

The straight pipe portion 4202 and the male coupling portion 422 of the second water inlet connecting pipe 242 may face the pump 12. The straight pipe portion 4202 and the male coupling portion 422 of the second water inlet connecting pipe 242 may be coupled to the water inlet end of the pump 12. The coupling body 4221 is inserted into the water inlet end of the pump 12, and the flange 4223 may be coupled around the water inlet end of the pump through the clamp 294.

The water outlet end of the pump 12 may be connected to the water inlet port 112 of the heat exchanger 11.

The water outlet pipe assembly 3 includes a plurality of injection molded pipes 31, 343, 342, 35, and the plurality of injection molded pipes may be coupled by the coupling of the male and female coupling portions and by the clamp 39.

The water outlet pipe assembly 3 may be arranged above the water inlet pipe assembly 2 and the pump 12. The water outlet pipe assembly 3 extends forward from the rear end at between the expansion tank 13 and the heat exchanger 11, and may be bent towards the heat exchanger 11 from a position ahead of the heat exchanger 11 and connected to the water outlet port 113 of the heat exchanger 11. The water outlet pipe assembly 3 and the water outlet port 113 may be coupled by the clamp 394.

The water outlet pipe assembly 3 may include the water outlet pipe 31. The water outlet pipe 31 includes a port coupling portion 311. The port coupling portion 311 is coupled to the discharge port 143.

The water outlet pipe 31 may penetrate the support panel 18. The water outlet pipe 31 may penetrate the support panel 18 and the rear panel 84 (see FIG. 3), and may be connected to an external water pipe through the discharge port 143 outside the casing 8.

The second temperature sensor 52 may be coupled to the water outlet pipe 31. The second temperature sensor 51 may measure the temperature of the water that is discharged from the heat exchanger 11 and supplied to the outside.

The temperature sensor installation portion 3151 may be molded as one body when the water outlet pipe 31 is injection molded. The water outlet pipe 31 may be injection molded from PA66. Other injection molded pipes of the water outlet pipe assembly 3 may also be injection molded from PA66.

This enables the temperature sensor 52 to be easily installed in the water outlet pipe 31. Furthermore, even after the product is installed at the intended location, the temperature sensor may be detached from the installation portion for repair, maintenance, and replacement.

The water outlet pipe assembly 2 may include a water outlet connecting pipe 34. One end of the water outlet connecting pipe 34 may be connected to the water outlet pipe 31 side, and the other end may be connected to the heat exchanger 11.

One end of the water outlet connecting pipe 34 may be connected to the water outlet pipe 31. The other end of the outlet connecting pipe 24 may be connected to a branch pipe 35.

The water outlet connecting pipe 34 may include a first coupling portion 431 (see FIG. 10) connected to the water outlet pipe 31 side and a second coupling portion 422 (see FIG. 9 connected to the heat exchanger 11.

One end of the water outlet connecting pipe 34, i.e., the first coupling portion 431, may be connected to the water outlet pipe 31. The other end of the water outlet connecting pipe 34, i.e., the second coupling portion 422, may be connected to the branch pipe 35.

The water outlet connecting pipe 34 may be arranged in front of the water outlet pipe 31 and the heat exchanger 11, and the first coupling portion 431 and the second coupling portion 422 may face rearward.

The water outlet connecting pipe 34 may include a straight pipe portion and a curved pipe portion. The water outlet connecting pipe 34 may include at least one straight pipe portion and at least one curved pipe portion.

The water outlet connecting pipe 34 may include a first water outlet curved pipe portion 4303 (see FIG. 10) arranged on the water outlet pipe 31 side. The water outlet connecting pipe 34 may include a second water outlet curved pipe portion 4203 arranged on the heat exchanger 11 side.

A first water outlet straight pipe portion 4301 may be arranged between the first water outlet curved pipe portion 4303 and the first coupling portion 431. The water outlet first straight pipe portion 4301 may be arranged parallel to the water outlet pipe 31.

The first water outlet curved pipe portion 4303 may be bent from the first water outlet straight pipe portion 4301 in a direction intersecting with the first water outlet straight pipe portion 4301. The first water outlet curved pipe portion 4303 may be bent from the first water outlet straight pipe portion 4301 in a direction perpendicular to the first water outlet straight pipe portion 4301.

A second water outlet straight pipe portion 4202 may be arranged between the second water outlet curved pipe portion 4303 and the second coupling portion 422. The second water outlet straight pipe portion 4202 may extend toward the heat exchanger 11. The second water outlet straight pipe portion 4202 may be parallel to the first water outlet straight pipe portion 4301.

The second water outlet curved pipe portion 4203 may be bent from the second water outlet straight pipe portion 422 in a direction intersecting with the second water outlet straight pipe portion 422. The second water outlet curved pipe portion 4203 may be bent in a direction perpendicular to the second water outlet straight pipe portion 422.

The straight pipe portion 4302, 4201 may be arranged between the first water outlet curved pipe portion 4303 and the second water outlet curved pipe portion 4203. The third water outlet straight pipe portion 4102 may extend from the first water outlet curved pipe portion 4303. The fourth water outlet straight pipe portion 4201 may extend from the second water outlet curved pipe portion 4203. The third and fourth water outlet straight pipe portions 4302, 4201 may be arranged in a straight line.

The third and fourth water outlet straight pipe portions 4302, 4201 may be connected to each other. The third connecting portion 432 is provided at the distal end of the third water outlet straight pipe portion 4302, and the fourth connecting portion 421 is provided at the distal of the fourth water outlet straight pipe portion 4201. The third and fourth connecting portions 432, 421 may be connected to each other.

The water outlet pipe assembly 3 may include a third connecting pipe 43. Hereinafter, the third connecting pipe 43 of the water outlet pipe assembly is also referred to as a first water outlet connecting pipe 343. The water outlet connecting pipe 34 may include a first water outlet connecting pipe 343.

The water connecting portion 312 of the water outlet pipe 31 may be connected to the first water outlet connecting pipe 343. The male coupling portion 312 of the water outlet pipe 31 may be coupled to the female coupling portion 431 (see FIG. 10) of the first water outlet connecting pipe 343.

The coupling body 3121 of the water outlet pipe 31 may be inserted into the accommodating portion 4312 of the first water outlet connecting pipe 343, and the gasket 49 arranged in the groove 3121 of the water outlet pipe 31 may seal the space between the male coupling portion 312 of the water outlet pipe 31 and the female coupling portion 431 of the first water outlet connecting pipe 343.

The male coupling portion 312 of the water outlet pipe 31 may be inserted into and coupled to the female coupling portion 431 of the first water outlet connecting pipe 343, and the flange 3123 of the water outlet pipe 31 and the flange 4313 of the female coupling portion 431 of the first water outlet connecting pipe 343 may be fixed by the clamp 391.

The first straight pipe portion 4301 of the first water outlet connecting pipe 343 may be arranged in a straight line with the water outlet pipe 31. The first straight pipe portion 4301 may be arranged in the front-rear direction. The curved pipe portion 4302 may be bent 90 degrees at between the first and second straight pipe portions 4301, 4302, so that the second straight pipe portion 4302 and the male coupling portion 432 may be arranged in a direction excluding the front-rear direction. The first straight pipe portion 4301 and the male coupling portion 432 may face the heat exchanger 11. The first straight pipe portion 4301 and the male coupling portion 432 may face the opposite side and the upper side of the heat exchange compartment 87.

The water outlet pipe assembly 3 may include a second connecting pipe 42. Hereinafter, the second connecting pipe 42 of the water outlet pipe assembly 3 is also referred to as a second water outlet connecting pipe 342. The water outlet connecting pipe 34 may include a second water outlet connecting pipe 342.

The female connecting portion 421 of the second water outlet connecting pipe 342 may be arranged parallel to the second straight pipe portion 4302 and the male coupling portion 432 of the first water outlet connecting pipe 343. The female coupling portion 431 of the second water outlet connecting pipe 342 may be coupled to the male coupling portion 432 of the first water outlet connecting pipe 341.

The coupling body 4321 of the first water outlet connecting pipe 343 may be inserted into the accommodating portion 4212 of the second water outlet connecting pipe 342, and the gasket 49 may seal the male coupling portion 432 of the first water outlet connecting pipe 343 and the female coupling portion 421 of the second water outlet connecting pipe 342. The flange 4323 of the male coupling portion 432 of the first water outlet connecting pipe 343 and the flange 4213 of the female coupling portion 421 of the second water outlet connecting pipe 342 may be coupled through the clamp 392.

The second water outlet connecting pipe 342 has a curved pipe portion 4203 arranged between the female coupling portion 421 and the straight pipe portion 4202, such that the straight pipe portion 4202 and the male coupling portion 422 may be arranged in different directions from the second straight pipe portion 4102 and the male coupling portion 412 of the first water outlet connecting pipe 241. The straight pipe portion 4202 and the male coupling portion 422 of the second water outlet connecting pipe 342 may face the heat exchanger 11.

The straight pipe portion 4202 and the male coupling portion 422 of the second water outlet connecting pipe 342 may be coupled to the first female coupling portion 351 of the branch pipe 35. The coupling body 4221 may be inserted into the accommodating portion 3512 of the first female coupling portion 351, and an O-ring 49 arranged in the groove 4222 may seal the space between the male coupling portion 422 of the second water outlet connecting pipe 342 and the first female coupling portion 351 of the branch pipe 35. The flange 4223 of the male coupling portion 422 of the second water outlet connecting pipe and the flange 3513 of the first female coupling portion 351 of the branch pipe 35 may be fixed through the clamp 293.

The water outlet port 113 may be inserted into the second female coupling portion 352 of the branch pipe 35, and fixed by the clamp 294. The air vent coupling portion 345 of the branch pipe 35 may be arranged to face upward. The air vent 54 may be inserted into the air vent coupling portion 345, and may be screw-connected with a screw thread 346. The branch pipe 35 is injection-molded from PA66, and the air vent coupling portion 345 may be formed as one body during the manufacturing of the branch pipe 35.

The water inlet pipe assembly 2 may be divided into three parts which are arranged in a straight line respectively. The water inlet pipe assembly 2 may include a first water inlet part 201 extending forward from the inlet port 142, a third water inlet part 203 extending forward parallel to the first water inlet part 201 from the water inlet end of the pump 12, and a second water inlet part 202 connecting the first water inlet part 201 and the third water inlet part 203.

The second water inlet part 202 may extend in a direction perpendicular to the first water inlet part 201 and the third water inlet part 203.

The first water inlet part 201 and the second water inlet part 202 may extend in a direction intersecting with each other. For example, the first water inlet part 201 may extend in the front-rear direction, and the second water inlet part 202 may extend from the first water inlet part 201 and be arranged on a plane perpendicular to the front-rear direction.

The third water inlet part 203 may extend in a direction intersecting with the second water inlet part 202, and may extend from the second water inlet part 202. The first water inlet part 201 and the third water inlet part 203 may extend in parallel.

Therefore, the water inlet pipe assembly may be arranged on a single plane.

The first water inlet part 201 may include the water inlet pipe 21, the pipe portion 232 of the flow meter, and a portion of the first water inlet connecting pipe 241.

A portion of the first water inlet connecting pipe 241 may include a female coupling portion 411 and a first straight pipe portion 4101.

A portion of the first water inlet connecting pipe 241 may further include a portion (e.g., half of the flow meter side) of the curved pipe portion 4103 of the first water inlet connecting pipe 241.

The second water inlet part 202 may include the remaining portion of the first water inlet connecting pipe 241, the female coupling portion 421 of the second water inlet connecting pipe 242, and a portion (e.g., half) of the female coupling portion 421 side of the curved pipe portion 4203.

The third water inlet part 203 may include a remaining portion of the second water inlet connecting pipe 242.

Similarly, the water outlet pipe assembly 301 may include a first water outlet part 301 extending forward from the discharge port 143, a third water outlet part 303 that extends forward from the water outlet port 113 of the heat exchanger 11 and is parallel to the first water outlet part 301, and a second water outlet part connecting the first and second water outlet parts 301, 302. The water outlet pipe assembly 3 may be arranged on a single plane.

The second water outlet part 302 may be arranged on a plane perpendicular to the forward-rear direction. The second water outlet part 302 may be orthogonal to the first and third water outlet parts 301, 303.

The first water inlet part 201 and the first water outlet part 301 may extend in the forward-rear direction at between the heat exchanger 11 and the expansion tank 13.

The water inlet port 112 and the water outlet port 113 may be arranged at the front of the heat exchanger 11. The water inlet port 112 and the water outlet port 113 may be arranged on the first water outlet part 301 and the first water inlet part 201 of the heat exchanger 11 in the left-right direction.

The first refrigerant port 117, 118 may be arranged at the front of the heat exchanger 11. The first refrigerant port 117, 118 may be arranged on the side panel 82 in the left-right direction.

The pump 12 may be arranged at the front of the heat exchanger 11, and a heat dissipation unit 121 may be arranged at the front of the pump 12. The heat dissipation unit 121 may emit heat from the pump 12 to the outside.

The front end of the first water inlet part 201 may be arranged rearward of the front end of the heat dissipation unit 121. The front end of the third water inlet part 203 may be arranged rearward of the front end of the heat dissipation unit 121.

The second water inlet part 202 may be arranged at a position corresponding to the heat dissipation unit 121 in the front-rear direction. That is, at least a portion of the second water inlet part 202 may overlap with the heat dissipation unit 121 in the lateral direction.

At least a portion of the second water inlet part 202 may be arranged rearward of the front end of the heat dissipation unit 121. The portion (i.e., the connecting pipe body 410, 420 of the first and second water inlet connecting pipe 241, 242) forming the pipe of the second water inlet part 202 may be arranged rearward of the front end of the heat dissipation unit 121.

The water outlet pipe assembly 3 may be arranged rearward of the second water inlet part 202. The water outlet pipe assembly 202 may be arranged above the pump 12.

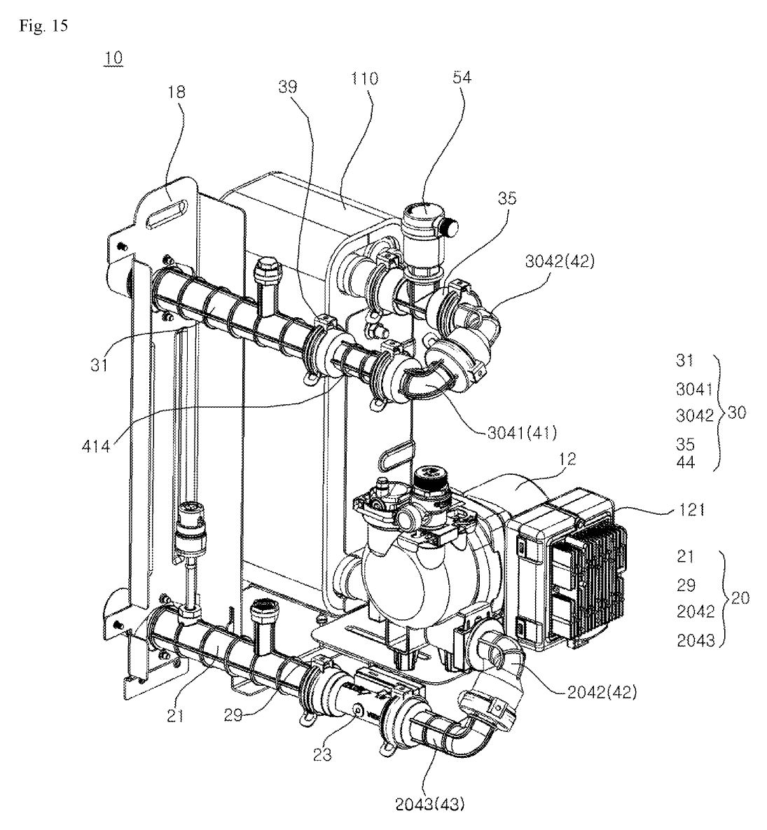

Hereinafter, with reference to FIG. 15, a water pipe module 10 according to a second embodiment of the present disclosure will be described based on differences from the water pipe module 1 according to the first embodiment described above. Some characteristics of the water pipe module 10 according to the second embodiment that are identical with or similar to those of the water pipe module 1 of the first embodiment will be omitted.

Referring to FIG. 15, the heat exchanger 110 of the present embodiment may have a larger capacity than the heat exchanger 11 of the first embodiment described above. For example, the depth of the heat exchanger 110 in front-rear direction may be greater than the depth of the heat exchanger 11 in front-rear direction of the first embodiment described above.

Accordingly, compared to the first embodiment described above, the branch pipe 35, the second water outlet connecting pipe 3042, the pump 12, and the second water inlet connecting pipe 2042 are moved forward by the difference in length of the heat exchanger 110.

Meanwhile, the positions of the support panel 18, the water inlet pipe 21, the water outlet pipe 22, and the flow meter 23 with respect to the rear surface of the heat exchanger 110 remain the same regardless of the change in the capacity of the heat exchanger.

This embodiment presents a modified water piping structure 20, 30 according to the change in capacity of the heat exchanger 110.

The water inlet pipe assembly 20 may include a water inlet pipe 21, a flow meter 23, and a second connecting pipe 42. The second connecting pipe of the water inlet pipe assembly 20 is also referred to as a second water inlet connecting pipe 2042.

The water inlet pipe assembly 20 may include a third connecting pipe 43. Unlike the previously described embodiment, the third connecting pipe 43 may be arranged between the flow meter 23 and the second water inlet connecting pipe 2042. The third connecting pipe 43 of the water inlet pipe assembly 20 may also be referred to as a first water inlet connecting pipe 2043.

The water outlet pipe assembly 30 may include a water outlet pipe 31, a second connecting pipe 42, and a branch pipe 35. Hereinafter, the second connecting pipe 42 of the water outlet pipe assembly 30 may also be referred to as a second water outlet connecting pipe 3042.

The water outlet pipe assembly 30 may include an extension pipe 44 connected to the water outlet pipe 31 and a first connecting pipe 41 connected to the second water outlet connecting pipe 3042.

The male coupling portion 312 of the first water outlet pipe 31 may be inserted and coupled to the female coupling portion 441 of the extension pipe 44, the male coupling portion 442 of the extension pipe 44 may be inserted and coupled to the female coupling portion 411 of the first water outlet connecting pipe 341, and the male coupling portion 412 of the first water outlet connecting pipe 3041 may be inserted and coupled to the female coupling portion of the second water outlet connecting pipe 3042.

That is, compared to the water pipe module 1 of the first embodiment, the water pipe module 10 of the present embodiment may increase the length in the front-rear direction of the water inlet pipe assembly 20 by replacing the first connecting pipe 41 in the water inlet pipe assembly 2, 20 with the third connecting pipe 43, and may increase the length in the front-rear direction of the water outlet pipe assembly 20 by replacing the third connecting pipe 43 in the water outlet pipe assembly 3, 30 with a pipe in which the extension pipe 44 and the first connecting pipe 41 are coupled.

For example, the length of the third connecting pipe 43 in the front-rear direction (i.e., in the direction parallel to the first straight pipe portion) 4301 may be longer than the length of the first connecting pipe 41 in the front-rear direction (i.e., in the direction parallel to the first straight pipe portion 4101). The length of the combination of the extension pipe 44 and the first connecting pipe 41 in the front-rear direction may be longer than the length of the third connecting pipe 43 in the front-rear direction. The difference between the length of the combination of the extension pipe 44 and the first connecting pipe 41 in the front-rear direction and the length of the third connecting pipe 43 in the front-rear direction may be equal to the difference between the length of the third connecting pipe 43 in the front-rear direction and the length of the first connecting pipe 41 in the front-rear direction.

Therefore, compared to the above-described embodiment, by adding only one member, i.e., the extension pipe 44, the lengths of both the water inlet pipe assembly 20 and the water outlet pipe assembly 30 can be increased, and the injection molded pipes can be shared.

According to at least one embodiment of the present disclosure, there may be provided a heat pump including a water pipe in which multiple pipes molded from a plastic material are coupled.

According to at least one embodiment of the present disclosure, there may be provided a heat pump in which a sensor coupling portion for coupling a sensor to the water pipe is formed on the water pipe without welding.

According to at least one embodiment of the present disclosure, there may be provided a heat pump having a reduced radius of curvature of the water pipe.

According to at least one embodiment of the present disclosure, there may be provided a heat pump capable of efficiently utilizing space within a machine compartment.

According to at least one embodiment of the present disclosure, there may be provided a heat pump having a water pipe adapted to different specifications by varying the coupling of multiple pipes.

According to at least one embodiment of the present disclosure, there may be provided a heat pump in which components within the machine compartment are arranged for easy installation, repair, and maintenance.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heat pump comprising:
a water inlet pipe assembly comprising a water inlet pipe, the water inlet pipe assembly being configured to receive water from an outside, the water inlet pipe comprising a plastic material;
a pump configured to circulate the water introduced from the water inlet pipe assembly;
a heat exchanger configured to exchange heat between the water circulated from the pump and a refrigerant; and
a water outlet pipe assembly configured to allow the heat-exchanged water to flow therethrough to the outside.

2. The heat pump of claim 1, wherein the water inlet pipe further comprises a sensor coupling portion which protrudes radially outward from the water inlet pipe and communicates with an internal flow path of the water inlet pipe, and
wherein a water inlet pipe sensor is coupled to the sensor coupling portion.

3. The heat pump of claim 2, wherein the water inlet pipe sensor comprises a first temperature sensor configured to measure a water temperature of the water inlet pipe, and
wherein the sensor coupling portion comprises a first temperature sensor coupling portion to which the first temperature sensor is coupled.

4. The heat pump of claim 2, wherein the water inlet pipe sensor comprises a pressure sensor configured to measure a water pressure of the water inlet pipe, and
wherein the sensor coupling portion comprises a pressure sensor coupling portion to which the pressure sensor is coupled.

5. The heat pump of claim 1, wherein the water inlet pipe further comprises:
a water inlet pipe body comprising an internal flow path; and
a port coupling portion located at an inlet end of the water inlet pipe body, and
wherein the water inlet pipe body and the port coupling portion are integrally formed.

6. The heat pump of claim 5, wherein the water inlet pipe body includes a radius that increases from a first end of the water inlet pipe body toward a second end of the water inlet pipe body.

7. The heat pump of claim 5, wherein the water inlet pipe further comprises a reinforcing rib protruding radially outward from the water inlet pipe body.

8. The heat pump of claim 5, further comprising an inlet port which is coupled to the port coupling portion, and connected to an external water pipe.

9. The heat pump of claim 5, further comprising a mount extending radially between the port coupling portion and the water inlet pipe body,
wherein the mount is formed integrally with the water inlet pipe body.

10. The heat pump of claim 1, wherein the water inlet pipe assembly further comprises a flow meter configured to measure a flow rate of water flowing into the water inlet pipe,
wherein the flow meter comprises a pipe portion coupled to the water inlet pipe, and
wherein the water inlet pipe further comprises a pipe coupling portion which is formed integrally with the water inlet pipe and coupled to the pipe portion.

11. The heat pump of claim 1, wherein the water inlet pipe assembly further comprises a water inlet connecting pipe, the water inlet connecting pipe comprising:
a first coupling portion connected to the water inlet pipe; and
a second coupling portion connected to a water inlet end of the pump, and
wherein the water inlet connecting pipe is made of a plastic material.

12. The heat pump of claim 11, wherein the water inlet connecting pipe further comprises:
a first water inlet connecting pipe comprising a first connecting portion, the first water inlet connecting pipe being bent laterally; and
a second water inlet connecting pipe connected to the first water inlet connecting pipe, the second water inlet connecting pipe being bent rearward to be connected to the water inlet end of the pump.

13. The heat pump of claim 1, wherein the water outlet pipe assembly comprises a water outlet pipe, the water outlet pipe including a plastic material.

14. The heat pump of claim 13, further comprising a second temperature sensor arranged in the water outlet pipe, the second temperature sensor being configured to measure a water temperature of the water outlet pipe,
wherein the water outlet pipe comprises a second temperature sensor coupling portion which protrudes radially outward from the water outlet pipe and communicates with an internal flow path of the water outlet pipe, and
wherein the second temperature sensor is coupled to the second temperature sensor coupling portion.

15. The heat pump of claim 13, further comprising an air vent,
wherein the water outlet pipe assembly further comprises a branch pipe connected to a water outlet port through which the water is configured to be discharged after leaving the heat exchanger, and
wherein the air vent is coupled to the branch pipe.

16. The heat pump of claim 1, wherein a front end of the water outlet pipe assembly is arranged rearward of a front end of the water inlet pipe assembly.

17. The heat pump of claim 1, wherein the water inlet pipe assembly further comprises:
at least one straight pipe portion; and
at least one curved pipe portion connected to the at least one straight pipe portion of the water inlet pipe assembly, and
wherein the water outlet pipe assembly comprises:
at straight one straight pipe portion; and
at least one curved pipe portion connected to the at least one straight pipe portion of the water outlet pipe assembly.

18. The heat pump of claim 17, wherein the at least one straight pipe portion of the water inlet pipe assembly is located closer to an inlet port of the heat pump than the at least one curved pipe portion of the water inlet pipe assembly, and
wherein the at least one straight pipe portion of the water outlet pipe assembly is located closer to an outlet port of the heat pump than the at least one curved pipe portion of the water outlet pipe assembly.

19. The heat pump of claim 18, wherein the at least one straight pipe portion of the water inlet pipe assembly is located below the at least one straight pipe portion of the water outlet pipe assembly.

20. The heat pump of claim 17, further comprising a pressure sensor configured to measure a water pressure and connected to the at least one straight pipe portion of the water inlet pipe assembly.
